(19) United States
(12) Patent Application Publication
(10) Pub. No.: US 2006/0020983 A1
(43) Pub. Date: Jan. 26, 2006

(54) Data transfer using existing communication systems

(76) Inventor: Jeng-Jye Shau, Palo Alto, CA (US)

Correspondence Address: JENG-JYE SHAU, 991 AMARILLO AVE., PALO ALTO, CA, 94303, US

(21) Appl. No.: 11/178,907

(22) Filed: Jul. 11, 2005

Related U.S. Application Data
(63) Continuation-in-part of application No. 09/539,309, filed on Mar. 30, 2000.

(51) Int. Cl. H04N 7/16; H04N 7/173

(52) U.S. Cl. 725/95; 725/62

(57) ABSTRACT

Data transfer system of the present invention examines existing communication methods for unused bandwidth. Data signals are inserted into communication signal when unused bandwidth is found. The resulting signal is still used for prior art communication without sacrificing quality. These data transfer methods provide an alternative high-bandwidth data path to Internet. It will satisfy the bandwidth requirement for many applications without any changes to existing system. The system requires little resource to implement. It is the most cost efficient method to solve the bandwidth problem, and the system can be established in a short time.

This application is a Continuation in Part (CIP) Application of pending U.S. patent application Ser. No. 09/539,309 filed on Mar. 30, 2000 by the Applicant of this patent applications. The disclosures made in Ser. No. 09/539,309 are hereby incorporated by reference in this Patent Application.

### BACKGROUND OF THE INVENTION

1. Field of the Invention

The present invention relates to information transfer methods, and more particularly to transfer methods using existing communication signals.

2. Description of the Reference Art

It is very clear that Internet is bringing revolutionary changes to human life. The world-wide-web allow easy individual access to information at anywhere in the world. It brings tremendous opportunities in business, revolutionary changes in education, and it will certainly change every aspect of our life style.

As Internet access gets more and more popular, data transfer bandwidth becomes a major problem. Today, telephone lines are still the major media for individual Internet connections. The 2.4 KHZ (thousand cycles per second) bandwidth for an end-user telephone line was adequate for voice transfer, but it is not designed to transfer large amount of data. Computer modem devices have been upgraded to 56 Kbps (thousand bits per second), but it is still far too slow. Many solutions have been proposed to solve the bandwidth problem. Among them, Integrated Services Digital Network (ISDN), fiber to home, and cable to home have been implemented at selected areas. However, those proposed new methods require tremendous amount of resource to implement, and it will take many years before it can reach individual users. Those new methods also represent tremendous wastes due to the burst nature of Internet access. An individual user would like to have a large bandwidth while accessing data, but most of time the individual line is not in use. An optical fiber to home is therefore a waste in bandwidth for most of time. Another important fact is that the bandwidth requirement from the user to the provider is usually very low. A human being can send out just a few commands per second. High bandwidth is often needed after the user request large amount of data from the provider. Providing the same bandwidth for both directions is therefore a waste. Further more, those new methods do not really solve the bandwidth problem for popular data providers. When thousands or millions of users request a popular web page at the same time, the provider does not have enough bandwidth to send out so many copies of data even if it is equipped with optical fiber.

The present invention provides a solution that can solve most of the bandwidth problems now. The proposal is to utilize existing TV networks to transfer data. Combining all the TV channels, the total bandwidth of TV signal is about one million times higher than a telephone line. The TV network already reaches nearly everyone in the world; it requires no new investment to implement. Since TV system is a one-way broadcast system, we will still need the telephone system to transfer low bandwidth tasks, while using TV to transfer most of data from providers to users. This combination of TV and telephone networks has enough capability to solve most of existing problems. The major challenge for this proposal is that almost all the bandwidth of TV channels has been used to transfer images to TV. Watching TV has been an important part of modern human life; any change in existing TV system will certainly encounter strong resistance. It is therefore strongly desirable to provide methods to transfer high bandwidth data using TV system without influencing TV viewers.

Existing television (TV) signal transfer methods are first reviewed to facilitate understanding of the issues. TV signal contains timing and color information to control the scanning electron beam hitting on a TV screen. FIGS. 1(a-g) shows the relationship between TV image and TV signal. Each picture is divided into a plurality of horizontal lines. The picture is created line by line with a scanning electron beam. Each line is composed of a plurality of picture elements (pixel). The size of each pixel is defined by the resolution of the image. For a color TV, a pixel is actually composed of three dots of three primary colors (red, green, and blue). The light density and color of each pixel is determined by the strength and location of the scanning electron beam in TV tube, which is controlled by the TV signal. Nearby lines belong to two separated frames. Half of the lines are scanned on the screen first, while the electron beam goes back to the upper left corner to scan the other half of interleaved lines. Display of 30 pictures or 60 frames in every second creates a motion picture.

FIG. 1(b) shows a snapshot of a typical TV signal waveform after it is demodulated. For every 1/60 seconds, a vertical synchronization (V sync) signal (111) marks the time when the scanning beam need to go back to upper left corner of the screen. The duration of this vertical sync signal, called “vertical blank interval” (112), is the time when the scanning beam needed to move from lower right corner back to upper left corner. There is a 15.75 KHZ horizontal synchronization (H sync) signal (113) that determines the time when the scanning beam should start on a new line. The duration of the horizontal sync signal called “horizontal blank interval” (114) is the time when the scanning beam move back from the right side of the screen to the left side to start on a new line. Video signal for one line of image (115) is transferred between horizontal sync signals. The amplitude of video signal varies between 0.3 to 1 volts. A voltage at 1 volt (white level) represents the brightest white color, while a voltage at 0.3 volts (black level) represents totally black. The voltages for both the vertical sync and the horizontal sync are at zero volts, which is called the “blank level”. The 0.3 volts difference between black level and blank level is designed to avoid false image during vertical and horizontal blank intervals.

For a black and white TV, the amplitude of the video signal (115) represents the light intensity along one horizontal line. It also includes frequency modulated (FM) audio signals. The video signal for color TV is more complex. Besides the FM audio signal, the color video signal contains three sets of signals as
Y=0.3R+0.59G+0.11B (1)
U=0.493(B−Y)p (2)
V=0.877(R−Y)q (3)
where R is the red light intensity, G is the green light intensity, B is the blue light intensity, Y is called the “luminance signal” that is equivalent to light density adjusted by color sensitivity of human eyes, U is the blue color differential signal, p is a phase factor representing a phase shift and a 4.43 MHZ carrier frequency shift, V is the red color difference signals, q is equal to p plus 90 degree phase shift. These signals are merged into the same bandwidth originally designed for black and white TV signals. The Y signal defines contrast of the image, so it occupies wider bandwidth, while U and V signals occupying narrower bandwidth. FIG. 1(c) shows the spectrum of one channel of TV signal. The audio signal is carrier by a narrow side band 6 MHZ (million cycles per second) above basic carrier frequency (CF). The luminance signal (Y) occupies spectrum between CF and audio side band. The color difference signals (U, V) occupies a side band centered at 4.43 MHZ above CF. The spectrum peaks of the color difference signals is carefully inserted between that of the luminance signals to minimize interference. This is possible only because the amplitudes of color difference signals (U, V) often follow that of luminance signal (Y). The color TV also uses another timing signal called “color burst” (117). The color burst (117) is placed at the back porch between the horizontal sync pulse and the start of video signal as shown in FIG. 1(b). The color TV signals are defined in this way in order to be compatible with black and white TV.

Besides sound and image, other types of information have been transferred through the TV signals taking advantage that part of those signals are not displaced on TV screen. For example, special binary signals are inserted into the “spare” time during the vertical blank interval to carry text. The video image near the edge of the TV screen is usually not displayed. It is therefore possible to transfer data through those “unused” lines. For example, TV signal line 7-18 and 320-331 are used to carry text signals that are only recognizable with special decoding circuits. For another example, TV decoder circuits replace Lines 22-24 and their companions lines 334-336 by special signals used for automatic gray scale compensation.

All these video, audio, timing, and special signals are all transferred by modulating high frequency carrier signals within a pre-defined standard bandwidth (˜8 MHZ). Signals from hundreds of TV channels are transferred in parallel using carefully defined carrier frequency; each channel occupies a well-defined bandwidth to avoid interference.

From the above descriptions, it is clear that all available bandwidth of TV system has been fully occupied. People already explored all kinds of methods to insert more information into the limited TV bandwidth. Using conventional methods to insert data into TV signals is therefore likely to cause interference. It is therefore highly desirable to invent novel methods to transfer high bandwidth data using TV signals without influencing the programs displayed for TV viewers.

Besides TV, the present invention is also applicable to other types of communication systems. One practical example is radio. Radio signals comprise frequency modulate (FM) or amplitude modulated (AM) signals centered at a predefined channel frequency. The simplicity of radio signal makes it suitable for many applications. In the past few years wireless communication systems, such as cellular phone systems or wireless internet systems, have grown into major communication networks. Modern wireless communication systems use “band width reuse” concepts to achieve amazing overall communication bandwidth. The potential and the flexibility to transfer large quality of data through those existing wireless network is higher than TV and radio combined. It is highly desirable to provide data transfer methods using those existing networks.

### SUMMARY OF THE INVENTION

The primary objective of this invention is, therefore, to provide practical methods to transfer data using existing communication signals without disturbing existing users. The other objective is to provide effective methods to find available bandwidth for data transfer methods of the present invention. Another objective is to provide methods to compensate the distortion caused by such data transfer. Another important objective is to provide methods to improve tolerance in noise. It is also a major objective of the present invention to provide efficient methods to work with other data transfer methods. Another major objective of this invention is to provide reliable emergency response system using existing communication systems.

These and other objectives are accomplished by novel methods in overlapping data signals with existing communication signals without causing sensible disturbs in conventional receivers.

While the novel features of the invention are set forth with particularly in the appended claims, the invention, both as to organization and content, will be better understood and appreciated, along with other objects and features thereof, from the following detailed descriptions taken in conjunction with the drawings.

### BRIEF DESCRIPTION OF THE DRAWINGS

FIGS. 1(a-g) show relationships between current art TV signal and TV display;

FIG. 2(a) is an example of a TV video signal with low contrast areas;

FIG. 2(b) is an example of the spectrum for a low contrast area;

FIG. 2(c) illustrates the spectrum after frequency modulated data signal has been inserted into the low contrast area in FIG. 2(b);

FIG. 2(d) illustrates the spectrum after multiple frequency data signal has been inserted into the low contrast area in FIG. 2(b);

FIG. 2(e) shows an example when amplitude modulated data signal is inserted into a low contrast area in FIG. 2(a);

FIG. 2(f) shows an example when compensated amplitude modulated data signal is inserted into a line next to the line in FIG. 2(e);

FIG. 2(g) shows an example when compensated amplitude modulated data signal is inserted into a low contrast area in FIG. 2(a);

FIG. 2(h) is an example of differential amplitude data signal;

FIG. 3(a) is the block diagram for a low contrast area data transfer system of the present invention;

FIGS. 3(c-d) are examples for the video signals in FIG. 3(a);

FIGS. 4(a-c) are examples for the video signals of black level data transfer method of the present invention;

FIGS. 5(a-c) are examples for the video signals of white level data transfer method of the present invention;

FIGS. 6(a-c) are examples for the video signals of blank level data transfer method of the present invention;

FIGS. 7(a-c) are the float charts for color table data transfer, pre-defined object data transfer, and invisible frame data transfer procedures;

FIG. 8(a) is a high level block diagram for a communication system of the present invention;

FIG. 8(b) is a block diagram for the layer structures of a communication system of the present invention; and

FIG. 9(a) shows the block diagram for a video game controller of the present invention;

FIG. 9(b) shows the float chart of the communication procedure for the controller in FIG. 9(a);

FIG. 10 illustrates a real-time stock price update system of the present invention;

FIGS. 11(a-c) illustrate data transfer methods of the present invention using existing radio broadcast systems;

FIGS. 12(a-c) illustrate data transfer methods of the present invention using existing wireless communication systems;

FIGS. 13(a-c) are general block diagrams for data transfer systems of the present invention;

FIGS. 14(a-b) show practical applications of the present invention especially for vehicle mapping devices; and

FIGS. 15(a-c) illustrate emergency response systems of the present invention.

### DETAILED DESCRIPTION OF THE INVENTION

The relationship between TV image and TV signal is described in further details to facilitate understanding of the present invention.

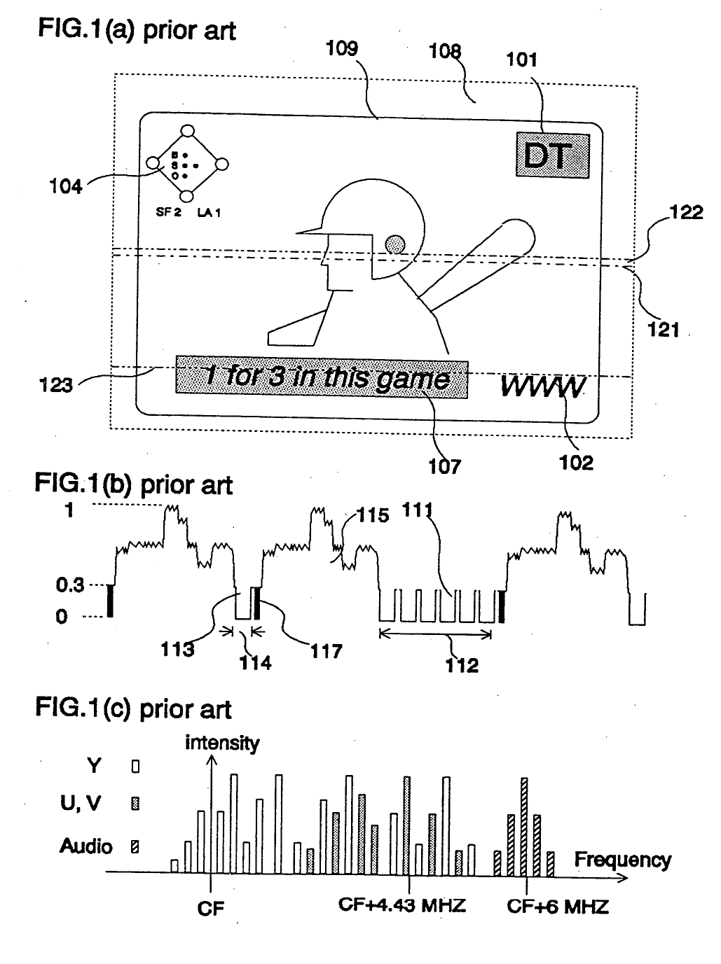

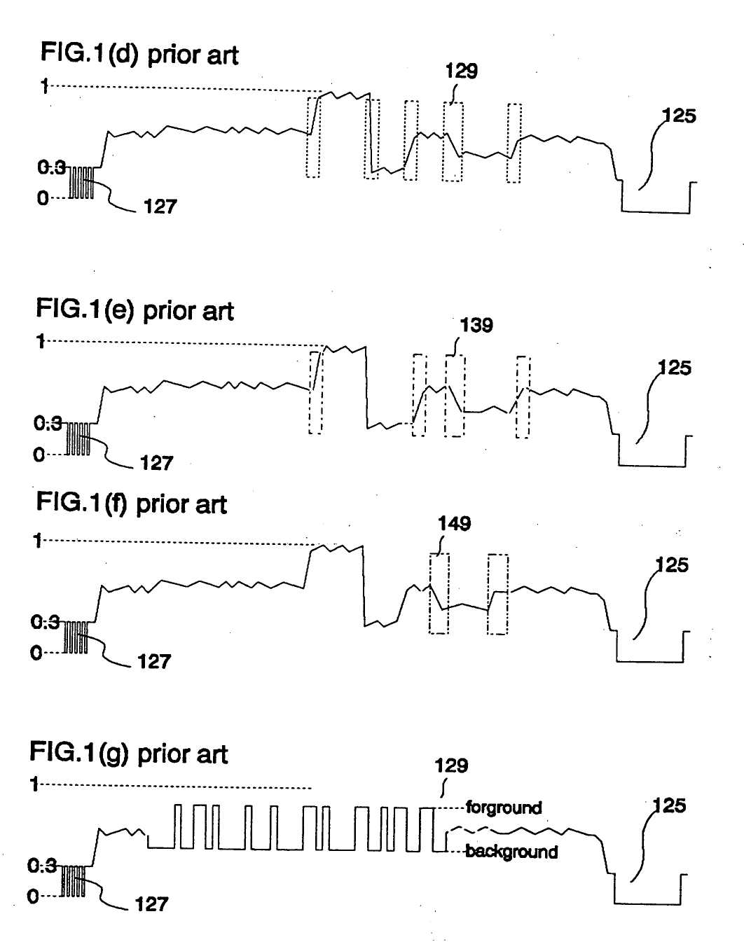

FIG. 1(d) shows the video signal waveform for one line (121) of the TV image displayed in FIG. 1(a). At the end of each line, an H sync (125) indicated the end of one line, and the electron beam is move back to the left side of the screen during the horizontal blank interval. The value of the TV signal during this interval is at blank level (0 volt). Each line begins when the signal returns from blank level to black level (0.3 volt). For a color TV signal, a color burst (127) composed of several pulses between blank and black levels is used to indicate the timing relationships between color (U, V) signals and luminance signal (Y). The signal stays at black level, then starts to vary from 0.3 to 1 volts to transfer the video signal on the line. A video signal at 0.3 volts means total black; there should be no light emitted from corresponding pixel. A video signal at 1 volt means white color at the highest luminance level of TV screen. Video signals between 0.3 and 1 volt represent various kinds of color and luminance. Areas where the video signal changes slowly along horizontal direction are called “horizontal low contrast” area. Areas where the video signal changes dramatically along horizontal direction are called “horizontal high contrast” areas (129) as marked by dashed lines in FIG. 1(d).

After the electron beam scans to the lower right corner, the beam is moved back to the upper left corner during the V sync interval. This motion is synchronized by the V sync signal (111) as shown in FIG. 1(b). The V sync signal (111) contains a plurality of pulses varying between blank and black levels. Sometimes, these pulses are also used to carry special information such as binary code for text display.

After the V sync interval, the electron beam starts to scan lines on a new frame, which are interleaved lines on the same picture of previous frame. FIG. 1(e) shows the video signal for a line (122) that is right next to the line in FIG. 1(d). This line belongs to the same picture at a different frame. Typically, the video signals for nearby lines are very similar; the signal only changes at positions where vertical image is changing. Areas where the video signal changes slowly along vertical direction are called “vertical low contrast” area. Areas where the video signal changes dramatically along vertical direction are called “vertical high contrast” areas (139) as marked by dashed lines in FIG. 1(d). Note that horizontal high contrast area is not necessary a vertical high contrast area. Similarly, a horizontal low contrast area can be a vertical high contrast area.

After the second frame is scanned, the electron beam starts to scan the image of the next picture after the V sync interval. FIG. 1(f) shows the video signal for the same line (121) as the line in FIG. 1(d) but for the next picture. Typically, the video signal of nearby pictures does not change much; the signal only changes at positions where image is changing with time. For the example in FIG. 1(a), only the bat of the baseball player is moving. Therefore, the video signal only changes around the bat. Areas where the video signal changes slowly with time are called “low moving contrast” area. Areas where the video signal changes dramatically with time are called “high moving contrast” area (149) as marked by dashed lines in FIG. 1(f).

Human eyes are sensitive to high contrast (horizontal, vertical, and moving) areas. Details in the low contrast areas are usually ignored. One example to illustrate the importance of the high contrast areas is text. FIG. 1(g) shows the video signal of one line (123) that displays the text box (107) on FIG. 1(a). In this example, text characters are displayed by using two monochromatic colors: the foreground color and the background color. Within the text box (107), the amplitude of the video signal in FIG. 1(f) stays constant until it hits the edges of character frames. The only high contrast area is therefore at the edges of character frames. For texts, characters are recognized correctly as soon as the edges of character frames are marked with high contrast area. Changes in the foreground and background areas will not change the information passing to us. Another important fact is the describing a two-color picture only needs two kind of signals; that means we do not need a lot of bandwidth to display simple objects like text. Text is just an example easy to understand. It is generally true that small changes in the low contrast area will not influence the information received by viewers. From signal processing point of view, the bandwidth reserved for each TV channel is defined to be enough to describe high contrast objects, while the low contrast areas do not require the same bandwidth. That means there is available bandwidth to transfer other information whenever the image has low contrast areas. The present invention provides methods to replace TV video signal with data signal while the resulting broadcast signal can be used for both TV display and data transfer. One data transfer method of the present invention is to use this available bandwidth in the low contrast areas to transfer data. This method is called “Low Contrast area Data Transfer” (LCDT).

Low Contrast Area Data Transfer (LCDT)

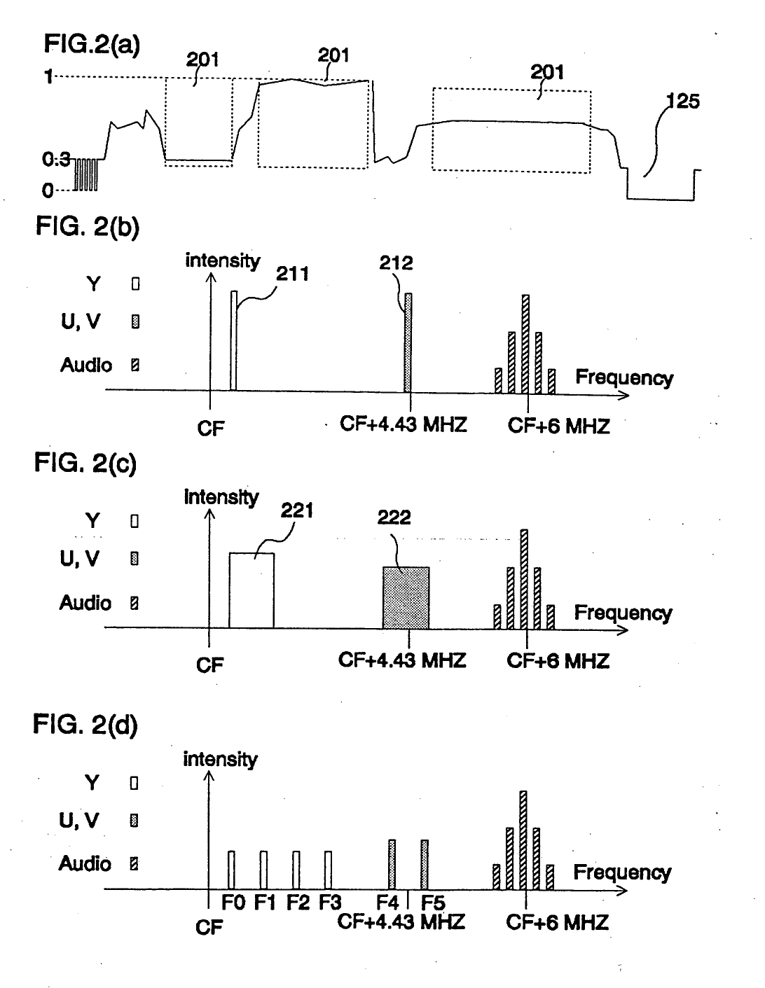

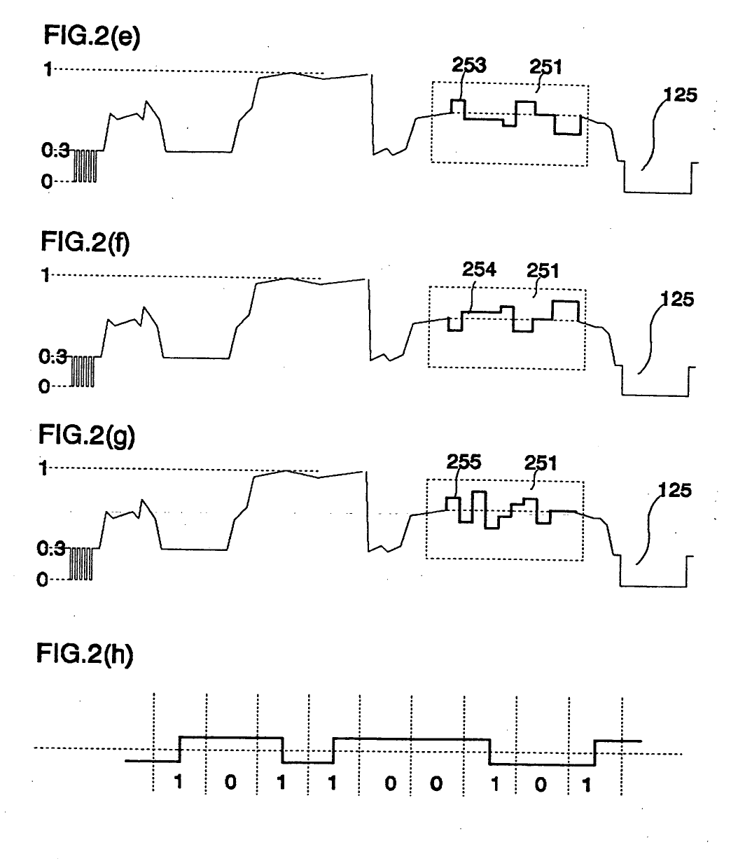

A low contrast area is an area where the video signal does not change rapidly. FIG. 2(a) shows an example of a video signal with three low contrast areas (201) marked with dashed lines. When a video signal has high contrast areas, the whole spectrum reserved for the channel would be crowded by the video signal, as shown in the example in FIG. 1(c). During the period of time when the video signal is in the low contrast areas (201), a small bandwidth is enough to carry the video information because the colors of all the pixels in the area are about the same. FIG. 2(b) shows an example of the spectrum for the video signal within a low contrast area. For color signals, there are two narrow spectrum peaks, one peak for luminance signal (211) and one peak for color difference signal (212); most bandwidth reserved for the TV channel is not used.

A data transfer method of this invention preserves original video information. That means the data signal must (1) stay within the bandwidth of the TV channel, (2) minimize the changes in video information. Data transfer that satisfies those requirements is described hereafter.

The color of a pixel is determined by the light intensity of three primary colors red, green and blue, i.e., R, G, B. This set of three light intensity is translated into a set of amplitude modulated (AM) video signal (Y, U, V). It is possible to represent the same video signal (Y, U, V) using different carry frequency side bands, as soon as the amplitude the resulting signal detected by TV receiver is correct. On the other word, frequency modulated (FM) signal can be embedded in the video signal without changing the meaning of video signal. This method is usually not useful because the result of frequency modulation will expand the bandwidth occupied by the video signal, causing distortion. In a low contrast area, we have available bandwidth to carry FM data signal without causing problem. FIG. 2(c) shows the spectrum when the video signal in FIG. 2(b) is carrying FM data. The effect of FM data modulation widens the spectrum peaks (221, 222). The effect of the data signal will not cause any change in video information as soon as the spectrum peaks are not wide enough to interfere with one another. Note that the luminance peak (221) and the color peak (222) can carry different sets of FM data separately. This frequency modulation to carry data signal does not influence the FM audio signal because the audio signal is carried by CF+6 MHZ side band.

A variation of FM format is the Multiple Frequency (MF) format. FIG. 2(d) shows the spectrum for one example of MF data. There are 4 luminance peaks centered at four frequencies (F0, F1, F2, F3). Data are represented by carriers of different frequencies within the bandwidth of the TV channel. For example, carrier frequency F0 represents binary data ‘00’, F1 represents ‘01’, F2 represents ‘10’, and F3 represents ‘11’. The amplitude of MF signal still can follow the original video signal. Based on the same principle, the color signal also can carry a different set of MF format data. For example, color signal centered at F4 carries binary data ‘0’; color signal centered at F5 carries binary data ‘1’.

Similar to the concept of FM signal, the data may be transferred by modulating the phase of the data carrier. This method is called Phase Modulated (PM) data transfer. Data are represented by the phase change in the carrier signal. A variation of PM data is the multiple phase (MP) data format. Data are represented by video signals with discrete phases.

Low contrast-area data transfer (LCDT) in frequency modulated formats such as transferred in FM, MF, PF, or MP format has the advantage that the amplitude of the original video signal remains the same. It is therefore possible to transfer data in the low contrast areas without any change in the video information. On the other hand, human eyes are not sensitive to small changes in a low contrast area. It is therefore possible to insert amplitude modulated (AM) signal in the low contrast area. FIG. 2(e) shows an example when an AM data signal (253) is inserted into one of the low contrast areas (251) of the video signal in FIG. 2(a). One problem for inserting data into video signal is that it may create a random background color fluctuation on the TV image. Although a TV viewer will have no problem recognizing the original image, this background fluctuation can be annoying. The present invention provides methods to solve this problem. One solution is to transmit data in compensated formats (CF). For each data modulation done on one pixel, opposite modulation is done on a nearby pixel to compensate it. Since human eyes automatically takes averaged images of fine objects, the resulting image of compensated format will be very close to the original image. There are three ways to transmit CF format data. The first way is to put the AM data of opposite amplitude in a nearby line. When the CF data is implemented on a nearby line, it is called “vertical compensation” (VC). The pre-requirement for VC is that both lines need to have vertical low contrast areas. The same method can be implemented on nearby pictures. When the compensating data is carried by the same line at a different picture, it is called “time compensation” (TC). The pre-requirement for TC is that both lines need to have low moving contrast areas. FIG. 2(f) shows a line of video signal that is carrying VC or TC data signal (254) compensating for the AM data (253) in FIG. 2(e). The third CF method is to carry the compensated data in nearby pixels on the same line. This format is called horizontal compensation (HC). FIG. 2(g) shows an example HC data (255). Naturally, we can use a combination of those three compensation methods (HC, VC, TC) to represent data. Also note that each point on the screen actually has three colors (R, G, B). The compensated format data (253-255) shown in FIGS. 2(e-g) are simplified for clarity. There are actually three degrees of freedom to represent and to compensate the modulated data. Data compensation can be implemented on one or more of the color components. The amplitude of the video signal is also not necessary linear proportional to the amplitude of light. Therefore, a proper compensation signal also needs to take alpha correction into consideration.

These compensation techniques (HC, VC, TC) not only improve picture quality, but also improve noise tolerance. When data is carried by compensated format, the data is determined by the changes in nearby points. Since most noise will have the same effects on nearby points, the resulting data signal has much better signal to noise ratio. This improvement in signal to noise ratio can allow us to carry more data in each point. The net result in data carrying capability is therefore not necessary worse than uncompensated data format.

Using compensated format, at least two pixels are required to carry each data point. In case it is not desirable to use multiple pixels to carry one data point, a differential format (DF) can be applied to solve the problem. FIG. 2(h) shows an example of data signal in differential amplitude (DA) format. Binary data ‘1’ is represented by a change in amplitude in either up or down direction, and binary data ‘0’ is represented by no change. If a parity bit is carried in every 8 data bits, it can be arranged to have the average amplitude to be zero for every 9 bits. The resulting disturbance in the original signal is therefore smooth and negligible. Similarly, the differential format can be employed to carry data signals with an FM, MF, PM, or MP formats. Naturally, combinations of multiple data formats, e.g., combinations of FM, MF, PM, MP, AM, CA, DA, can be employed to achieve higher data transfer rate when necessary.

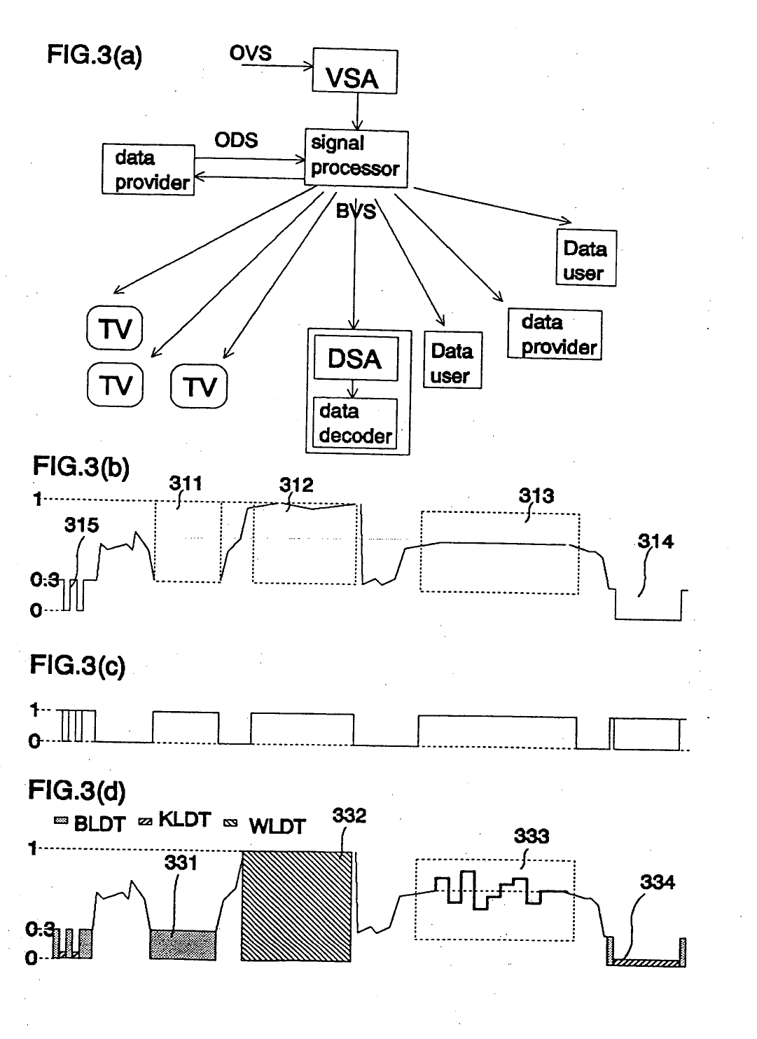

FIG. 3(a) shows the block diagram for a hardware system executing a low contrast area data transfer (LCDT) process. A video signal analyzer (VSA) examines the outgoing video signal (OVS) looking for available bandwidth. This video signal analyzer detects changing rate of the out going video signal (OVS). Whenever low contrast areas are detected, the VSA sends signals to a signal processor. In the mean time, the data providers also send data to the signal processor for data transfer. This signal processor inserts outgoing data signal (ODS) into the outgoing video signal (OVS) to create broadcast video signal (BVS). The BVS is broadcast through TV systems. Both TV users and data users receive and process the broadcast video signal. Data transfer methods of the present invention preserve the quality of video signal. The TV receivers process the BVS the same way as before, not affected by the data signal carried along with the broadcast video signal, to display high quality pictures with the processed BVS. The data receiver has a data signal analyzer (DSA) and data decoder. The DSA examines BVS and sends out a signal to the data decoder whenever data signal is found. The data decoder filters the right signal out of BVS, and extracts the correct data for the data user.

As an example, after processing the video signal shown in FIG. 3(b), the output generated by a low contrast area data transfer (LCDT) VSA would look like FIG. 3(c). Whenever the signal in FIG. 3(b) has a changing rate less than a pre-defined limit, the output of the level sensor is binary ‘1’, otherwise it is ‘0’, as shown in FIG. 3(c). There are three low contrast areas (311-313) in the video signal of the example in FIG. 3(b). In the mean time, the areas allowed for timing control signals, e.g., vertical sync, horizontal sync, and color burst, automatically meets the requirements for a low contrast area. Therefore, the signal in FIG. 3(c) also goes high during the horizontal blank interval. When OVS stays in low contrast area long enough to carry data, data signal is inserted to create the BVS as shown in FIG. 3(d). The data can be transferred using any one or any combination of the formats (FM, PM, MF, MP, DA, CA, CP) of the present invention. The LCDT data signal analyzer (DSA) also has the capability to detect low contrast area. Whenever a low contrast area is found, the data decoder will look for overlapped data signal, and extract the data by demodulation procedures.

The optimum data transfer rate of LCDT is strongly dependent on the video signal. Higher data rate can be achieved for special types of TV signals. For example, special data transfer rate can be achieved when the low contrast area is at black level. A Black Level Data Transfer (BLDT) method is disclosed in the present invention to take advantage of the special data transfer rate achievable in the black-level low contrast area. Similarly this invention also applies a White Level Data Transfer (WLDT) method by taking advantage of the higher data transfer rate in a white-level low contrast area. Furthermore, this invention also discloses a Blank Level Data Transfer (KLDT) method carry the data signals in a blank-level low contrast area. FIG. 3(d) shows example for the situations when BLDT (331), WLDT (332), common LCDT (333), KLDT (334) are used for the example video signal in FIG. 3(b). These data transfer methods at extreme cases (BLDT, WLDT, KLDT) are described in further details hereafter.

Black Level Data Transfer (BLDT)

Video signals with a voltage level representing the black color are one of the signals most frequently transmitted to the TV receivers. Black as a color is frequently displayed on TV screen. Also, the signal's voltage level is applied as the upper level for video timing signals (H sync, V sync, color burst). In optical terms, black means no light. When the video signal is at black level, the corresponding picture element (pixel) should be totally black on the TV screen. According to optical concept, it is impossible to have a color darker than black. For TV signals, Black level is represented by an amplitude-modulated (AM) signal at 0.3 volts. The black level is set at 30% of full-scale amplitude because there is a need to have enough margin to define the “blank level” used for timing signals. Ideally, a video signal should never have a value between black level and blank level because nothing can be darker than black while it is not a timing signal.

In reality, a video signal lower than black level will be processed by the receiver as black, immediately after the receiver circuits detect a video signal level lower than the black level. In practical conditions, a spot on the TV screen can not be totally black; the TV screen may reflect lights from nearby light source even when the screen itself is not emitting light. Therefore, a video signal slightly higher than black level can be treated as black in practical conditions. The concept of “black” is therefore not strictly defined as represented by one-and-only signal level. The TV signals with amplitudes between lower black level and upper black level represent the same signal as far as TV display is concerned. It is therefore very convenient to carry along data signals with a signal representing black spots for TV display. The only limitation is to have the overlapped signals remain within the black level range. It should also be noted that the black level range is not a fixed signal range. At areas right next to a timing signal, the black level need to be accurate; at other areas, black level range can be very wide. The exact value for black level range is also dependent on the design of TV receiver circuits.

Another important factor is that black is not processes as a color signal and mathematically black signal means R=G=B=Y=U=V=0. Therefore, there are full freedom to represent black using different carrier signals, as soon as the resulting amplitude fall between the upper and lower black levels.

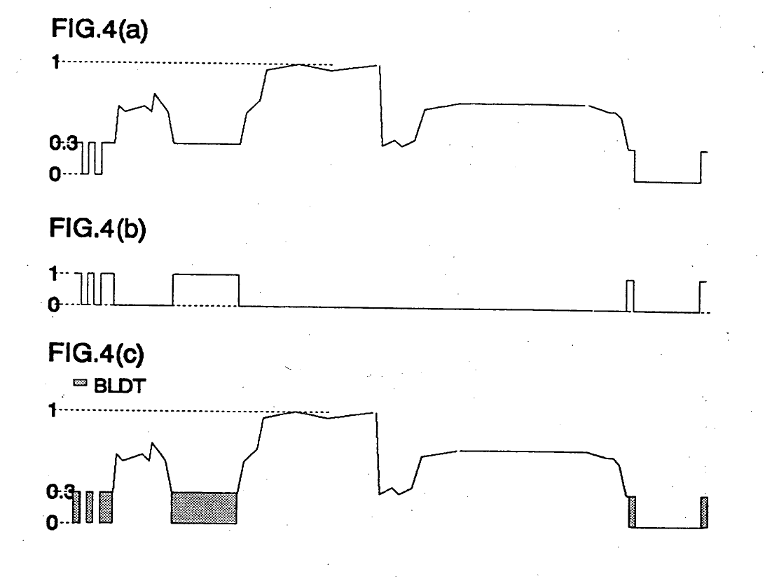

To support BLDT, the VSA and DSA need to have a level sensor. This level sensor examines the video signal, and sends out a control signal whenever the video signal is within black level range. Using the video signal in FIG. 4(a) as an example, the BLDT signal analyzer output would look like FIG. 4(b). Whenever the signal in FIG. 4(a) is within black level range, the output of the level sensor is binary ‘1’, otherwise it is ‘0’, as shown in FIG. 4(b). When the video signal is found to stay within black level range long enough to carry data, data signal is inserted into the original video signal to create the video output signal as shown in FIG. 4(c). One obvious problem for the AM data signal in this example is noise sensitivity. The black level range is only a fraction of full-scale amplitude. The signal to noise ratio is therefore much smaller than TV signals. One solution to solve the noise problem is to use frequency modulation methods. Since black level does not have color information, we can change phase and frequency without influencing the quality of video display. Using FM methods we can keep the amplitude of the black level signal at 0.3 volts, while carrying high bandwidth data signal with FM, MF, PM, or MP methods described in previous sections. Because the amplitude of data signal is 0.3 volts, excellent signal to noise ratio can be achieved.

A narrow side band within the TV channel to carry the AM signal can be employed to improve noise tolerance for amplitude modulated black level data transfer (AMBLDT). A filter can also used to filter out most of noise at other frequencies and a compensated or differential format is also used for AMBLDT. Naturally, two or more of the data transfer formats of the present invention such as FM, PM, MF, DA, CA. CP described above can be combined to achieve higher data transfer rate.

White Level Data Transfer (WLDT)

The concept of “white” for TV display is not the same as natural white color. In optical terms, white means a color with balanced color components as R=G=B. There is no limitation on the density of natural white light. For a TV display, the density of light emitted from the screen has a physical limit. Therefore, the TV signal has an upper limit on its amplitude. The concept of white for TV display means a light spot reaching the luminance limit of the TV screen with balanced color components as Y=R=G=B=1. Note that R=G=B is not enough to be defined as “white” for TV display; it is “gray” if Y is not at full scale. From electrical signal point of view, “white” is a signal with white level amplitude, that is, at 100% of full-scale amplitude. In reality, there is also an upper white level and lower white level. TV signals with amplitudes between upper and lower white level (white level range) will display “white” on TV screen. TV viewers can not distinguish any difference as soon as the signal is within white level range. Because “white level” is not strictly defined, we can use it to transfer more data in similar ways as BLDT. However, there is a major difference between WLDT and BLDT. For WLDT, if we change Y without changing color difference signals U and V, there will be differences in color. The color difference signals (U, V) occupies a side band centered at 4.43 MHZ above CF. The need to have balanced color reduced the degree of freedom in choosing frequency side bands for WLDT. On the other hand, WLDT signals are at full-scale amplitude, so that its noise tolerance is better than BLDT.

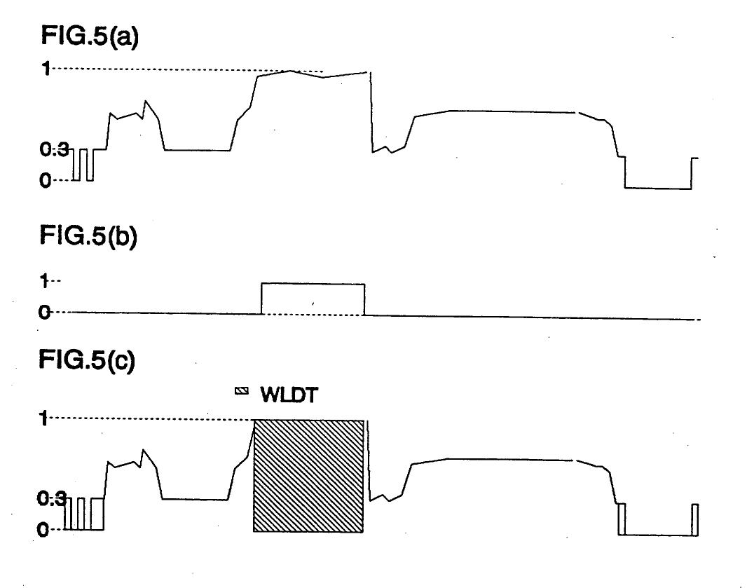

To support WLDT, the VSA and DSA need to have a level sensor. This level sensor examines the video signal, and sends out a control signal whenever the video signal is within white level range. Using the video signal in FIG. 5(a) as an example, the WLDT signal analyzer output would look like FIG. 5(b). Whenever the signal in FIG. 5(a) is within black level range, the output of the level sensor is binary ‘1’, otherwise it is ‘0’, as shown in FIG. 5(b). When the video signal is found to stay within black level range long enough to carry data, data signal is inserted into the original video signal to create the video output signal as shown in FIG. 5(c). The data can be transferred using any one or any combination of the formats (FM, PM, MF, DA, CA. CP) described in previous sections. Unlike BLDT, for WLDT selection of the phase and frequency of the carrier signal need to take color into consideration.

Blank Level Data Transfer (KLDT)

Blank level is used for timing signals such as horizontal sync, vertical sync, and color burst. Blank signal should have zero amplitude. In reality, timing circuits are most sensitive to the falling and rising edges of the timing signals. Other than those edges, timing circuits can tolerate signals with amplitude smaller than the blank level limit as blank signal. Therefore, we can insert data signals to replace blank signals as soon as the amplitude of the inserted signal is lower than the blank level limit.

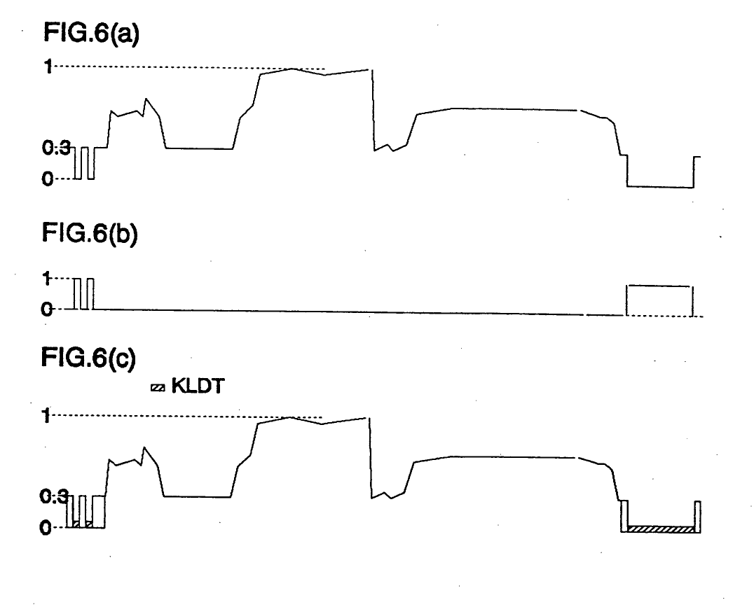

To support KLDT, the VSA and DSA need to have a level sensor. This level sensor examines the video signal, and sends out a control signal whenever the video signal is below blank level limit. Using the video signal in FIG. 6(a) as an example, the KLDT signal analyzer output would look like FIG. 6(b). Whenever the signal in FIG. 6(a) is below blank level limit, the output of the level sensor is binary ‘1’, otherwise it is ‘0’, as shown in FIG. 4(b). When the video signal is found to stay within blank level range long enough to carry data, data signal is inserted into the original video signal to create the video output signal as shown in FIG. 6(c). The data can be transferred using any one or any combination of the formats (FM, PM, MF, DA, CA. CP) of the present invention. Similar to BLDT, we have total freedom to select the phase and frequency of the carrier signal because blank level does not have color.

The data transfer methods using the available bandwidth in the low contrast areas (LCDT, BLDT, WLDT, KLDT) have been disclosed in the above sections. Those methods provide data transfer bandwidth whenever the video signal is in low contrast areas. The average data transfer rate is therefore dependent on the property of TV image. For many types of applications, it is desirable to have a steady data transfer rate. Therefore, the present invention provides data transfer methods with transfer rate independent of the TV image, as disclosed hereafter.

Color Table Data Transfer (CTDT)

Color table is commonly used for computer display as a method to reduce the size of graphic files. A color table defines a finite number (16, 64, or 256) of colors. The color of each pixel in a picture is represented by one of the color in the color table that is closest to the original. For most cases, a 256-color table is adequate to display high quality pictures, especially when the content of the color table can be changed to adapt for different pictures. Definition of the colors in the color table is not unique. We can replace every entry of a color table with similar but different colors to create another table. The new table will still be able to represent high quality pictures. This property is used by a data transfer method of the present invention called color table data transfer (CTDT).

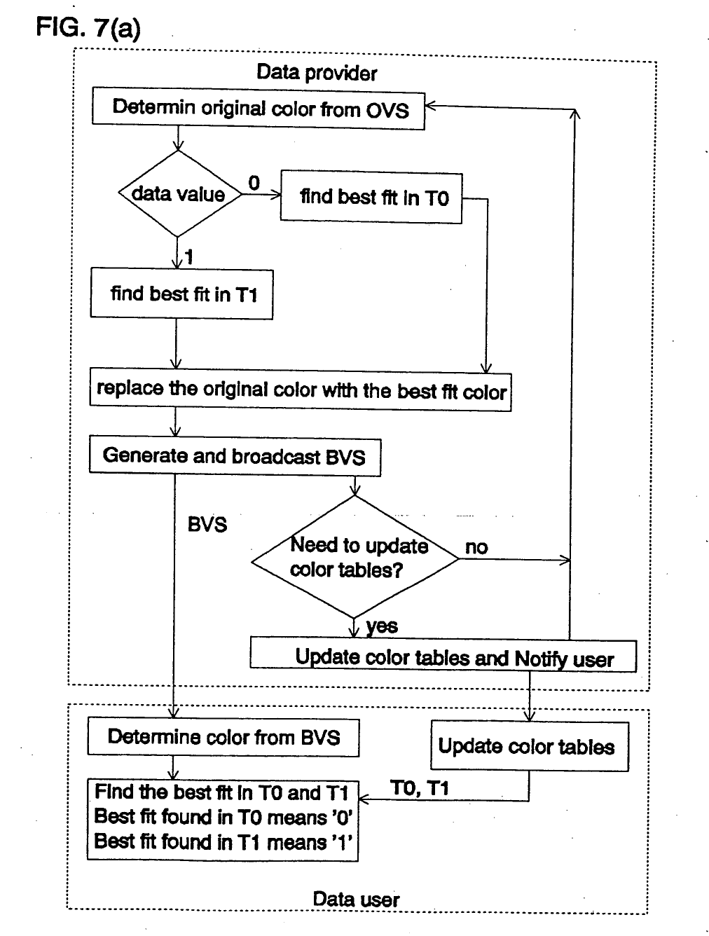

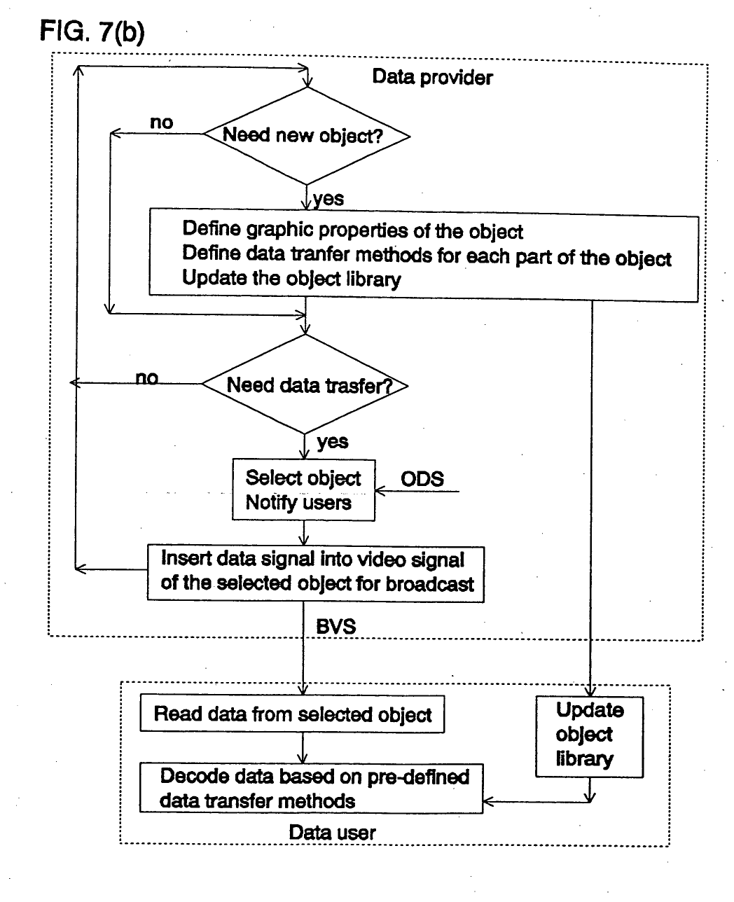

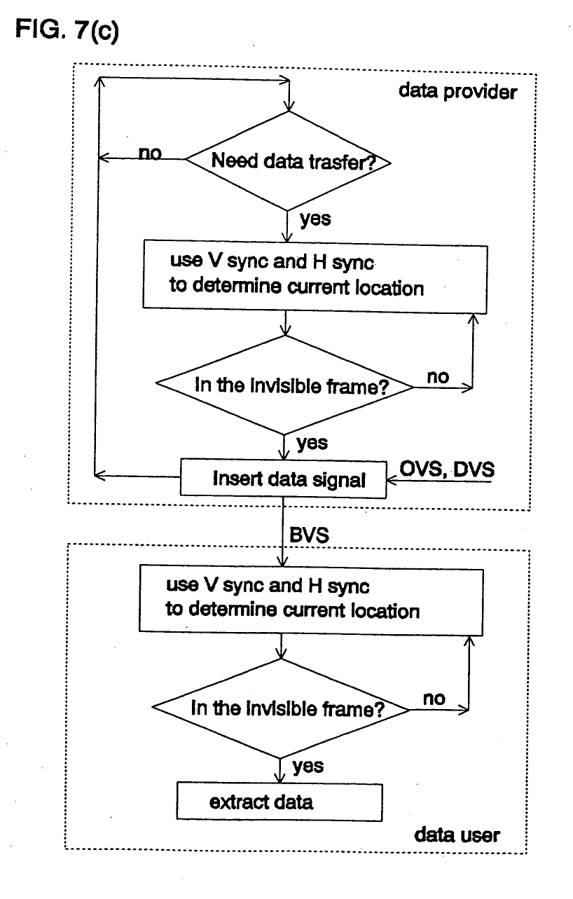

To support CTDT, both the data provider and data receiver need to agree upon two or more pre-defined color tables, e.g., T0 and T1 where T0 represents the first color table and T1 represents the second color table. These color tables can be changed but all the tables need to be coherent. FIG. 7(a) shows the flow chart for CCDT procedures. A video signal analyzer (VSA) determines the color for each pixel in the original video signal (OVS). For transmitting a binary number ‘0’, the color of the pixel is replace by the best fit in table T0, and for transmitting a binary number ‘1’, the color of the pixel is replace by the best fit in table T1. The resulting picture (BVS) is broadcast through TV network. Since both color tables T1, T0 are provided for producing high quality pictures, the resulting mixed video signal will be able to provide high quality display for TV viewers. A data receiver uses a data signal analyzer (DSA) to examine the BVS. When the color of a pixel is found in T0, a binary number ‘0’ is received. When the color of a pixel is found in T1, a binary number ‘1’ is received.

CTDT has the advantage that a data binary bit may be into every pixel of the video signal. It is not necessary to consider possible interference to the quality and color variations of the video signals due to the insertion of data. It is therefore not necessary to first determine the low contrast areas. CCDT data transmission can be flexibly applied to different portions of the display signals and does not have to be applied to the whole screen. It is usually advantageous to transfer data on part of the screen where a small color table may be used (e.g. 16 or 64 colors) to simplify supporting circuits.

Pre-Defined Object Data Transfer (PODT)

A pre-defined object (PO) is an object that is known to both the data sender and the data receiver. Examples of pre-defined objects are logo (102), score board (104), and caption frame (107), as shown in FIG. 1(a). Pre-defined objects usually are simple graphic figures with simple color pattern so that multiple methods of this invention (LCDT, BLDT, WLDT, CTDT) can be used to achieve high data transfer rate. Because we know exactly the color of each pixel, further data transfer methods are available. For example, an area in the PO can be designated to fill with any video signal. In this way, there will be no constraint on the data signal format within that area. Maximum bandwidth can be achieved within such area. Both the data sender and the data receive should have a PO library. For each PO in the library, the original color and the data transfer methods of every pixel is defined. To start a data transfer using PODT, the data provider simply notifies the data user when, where, and which PO is going to be used. FIG. 7(b) shows the flowchart as one example for showing the processing steps carried out to insert data into the pixels of the pre-defined object data for transferring data using the PODT procedure.

Small Object Data Transfer (SODT)

Human eyes are not sensitive to a small object on a large picture. If we select a few pixels on the screen to carry data, the effect of the data won't be visible as soon as the selected area is small enough. These small objects can be placed at a fixed place on the screen. It also can be a moving small object. The location even can be randomly selected as soon as both the sender and the receiver know which pixels are carrying data. We have total freedom to use any combination of data formats of the present invention within the small object. Any combinations of the data formats of the present invention can be used for SODT. The data transfer procedures for SODT is the same as PODT as shown in the float chart in FIG. 7(b).

Invisible Frame Data Transfer (IFDT)

Not all the video signals are displayed on TV screen. The first and last few lines of each frame are not displayed. The first and the last few pixels of each line are not displayed. Those lines and pixels outside of TV screen (109) are called the “invisible frame” (108). We can replace video signals in this “invisible frame” (108) with data signals as soon as (1) the spectrum of the data signal is within the bandwidth of the TV channel, (2) the amplitude of the data signal is within the ranges of conventional video signal, and (3) the timing signals (V sync, H sync, color burst) are preserved correctly. A data transfer method of the present invention using the invisible frame for data transfer is called “Invisible Frame Data Transfer” (IFDT). Since the video signal in the invisible frame is not used for TV display at all, there is highest degree of freedom in the data transfer format for IFDT. It is important to remember that there are prior art methods using part of the invisible frame to carry text. These prior art text signals always use blank level and black level. One way to maintain compatibility is to use BLDT and KLDT when the signal in the invisible frame is found to be at black level or blank level. For other levels, we have total freedom to use any combination of data formats of the present invention.

To support IFDT, the video signal analyzer (VSA) and the data signal analyzer (DSA) need to have a timing circuit. This timing circuit uses the video timing signals (V sync and H sync) and an internal timer to determine if the signal is within the invisible frame. When the video signal is found to stay within the invisible frame, data signal is inserted into the original video signal to create the video output signal. The data can be transferred using any one or any combination of the formats described in previous sections. FIG. 7(c) shows the float chart for one example of IFDT procedure.

Dedicated Object Data Transfer (DODT)

While data transfer methods of the present invention is able to transfer data through TV signals without degrading picture quality, it is still not ethical to change the video signal without notifying TV viewers. Honesty is the best policy. We should always notify the TV viewers whenever we are using the video signal to transfer data. One way to do that is to display a special symbol (101) on one corner of the screen as shown in FIG. 1(a). In this example, we use characters “DT” to notify TV viewers that data transfer is executed. In case that the data transfer procedure indeed causes annoying effects, the TV viewers can feedback the problem to the data provider, and the data transfer methods should be improved. Naturally, the DT symbol (101) can be used for data transfer. One of the simplest methods to transfer data is to dedicate a small portion of the TV screen for data transfer. This method is called Dedicated Object Data Transfer (DODT) method. The data transfer procedures for DODT is the same as PODT as shown in the float chart in FIG. 7(b).

The present invention provides effective methods to utilize the TV network as a parallel path for Internet communication. Combining the data transfer methods (BLDT, WLDT, KLDT, VSDT, CTDT, PODT, SODT, IFDT, DODT) of the present invention, more than 90% of the TV bandwidth will be available for data transfer. The bandwidth for each pixel on a TV screen is about equal to 6 phone lines. If all the available TV channels are fully utilized, more than one billion bits per second (Gbps) is transmissible to every user in the world.

While specific data transfer methods of the invention have been illustrated and described herein, it is realized that other modifications and changes will occur to those skilled in the art. It should be understood that the above particular examples are for demonstration only and are not intended as limitation on the present invention.

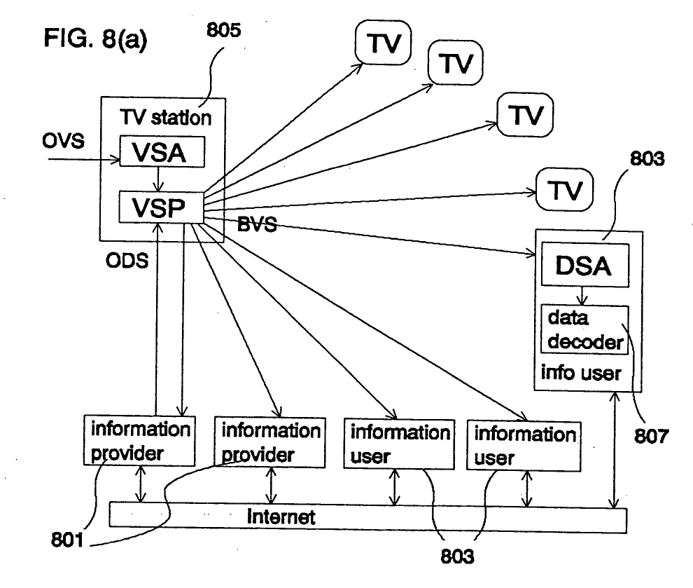

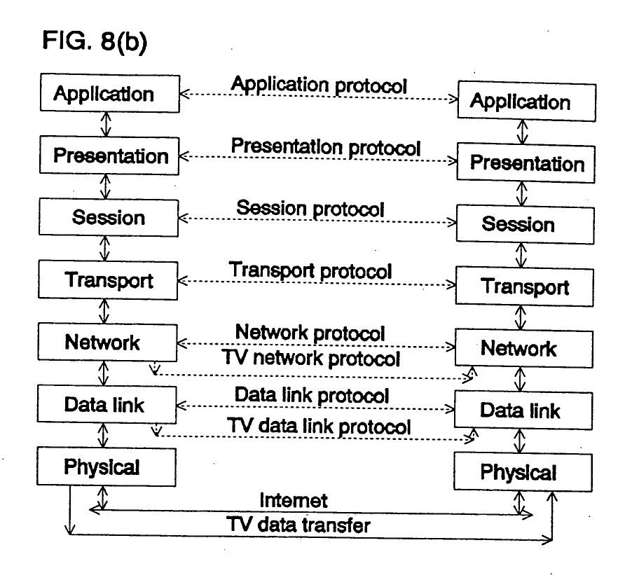

A data transfer system of the present invention does not replace existing communication systems. Instead, it provides additional data path to existing systems. FIG. 8(a) shows a broad view of a communication system of the present invention. Information users (801) and information providers (803) are connected through Internet. Currently, the backbone of Internet is built on telephone systems and computer networks. In the mean time, TV stations (805) broadcast video signals to TV viewers. Currently, there are no connections between Internet and TV networks. Information users (801) send requests, commands, selections, and simple e-mails through the Internet. Usually those activities require little bandwidth; a simple telephone line is more than enough to handle them. Currently, the information providers (803) also use Internet for data transfer. The bottle neck is the bandwidth requirement for a popular Web site to send large data files to users. The present invention provides an alternative data path. Information provider can send data to a TV station with a data encoder of the present invention. This data encoder contains a video signal analyzer (VSA) and a video signal processor (VSP). The video signal analyzer (VSA) examines the outgoing video signal (OVS) looking for available bandwidth. The output of VSA is sent to VSP to select proper data transfer methods. This signal processor (VSP) inserts outgoing data signal (ODS) into the outgoing video signal (OVS) to create broadcast video signal (BVS). The BVS is broadcast through TV systems, and it is processed by both TV receivers and data users (801). Data transfer methods of the present invention preserve the quality of video signal, so that the TV viewer still can receive high quality video display using BVS. The data receiver has a data signal analyzer (DSA) and data decoder (807). DSA examines BVS and sends out a signal to the data decoder (807) whenever data signal is found. Control information such as the type of data transfer and the encoding keys are provide by the information providers (803) either through Internet or transferred as part of ODS. The data decoder (807) filters the right signal out of BVS, and extracts the correct data for the data user. This alternative data path through TV network has much wider bandwidth then the telephone networks. It is therefore possible to improve overall system performance dramatically. FIG. 8(b) shows the layer structure of the system in FIG. 8(a). Most of the layer structures and communication protocols are the same as those of current art communication systems. There are no changes on application, presentation, session, and transport layers. Therefore, a communication system of the present invention can use most of existing software and hardware. The present invention provides one way parallel paths in the lower level layers.

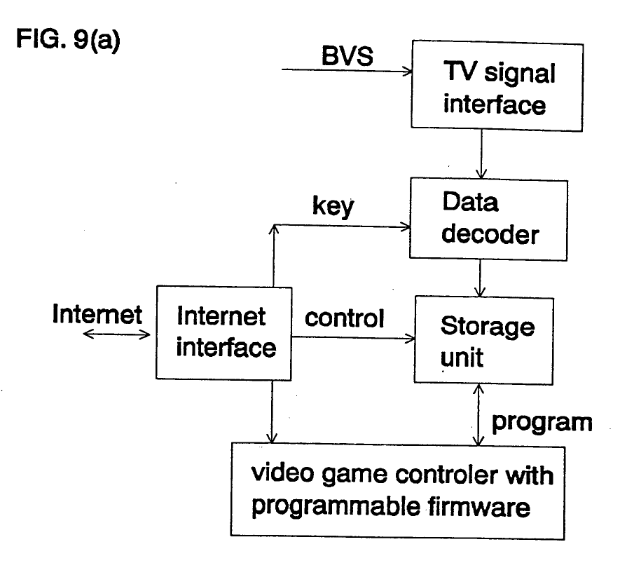

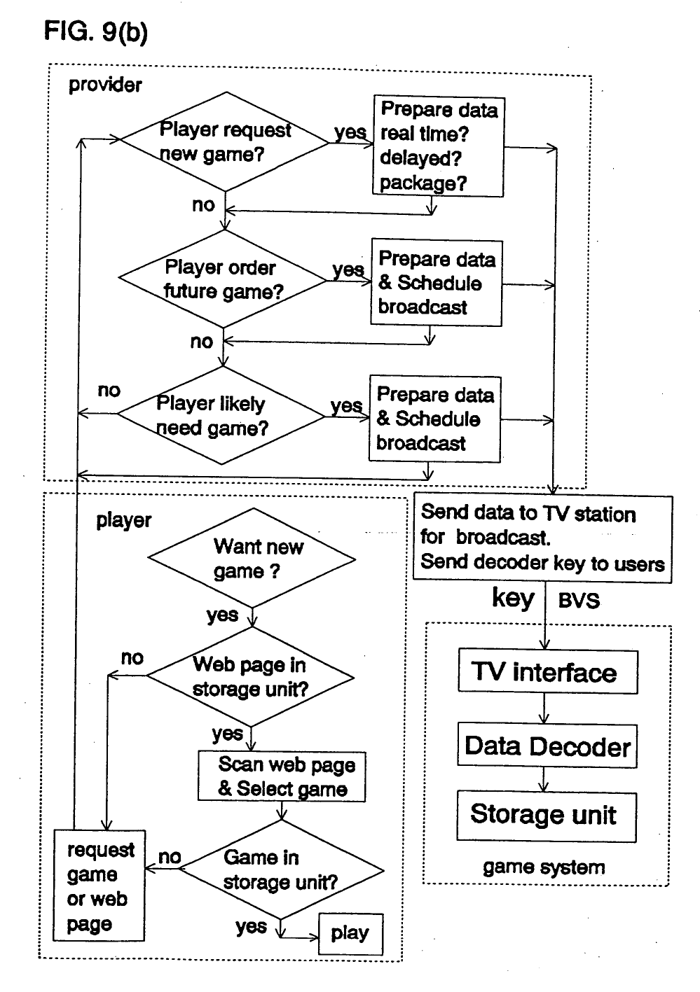

The system in FIG. 8(a) can be used in a wide variety of communication applications. We will use a video game rental system as an example to demonstrate operation principles for communication systems of the present invention. FIG. 9(a) shows the block diagram for a video game controller of the present invention. This video game controller is equipped with a TV signal interface (901) for receiving television signals. Typical examples for this TV signal interface (901) are connections to TV antenna or cable TV box. TV signal received by the TV interface (901) is sent to a data decoder (903). The data decoder (903) is used to extract data from TV signal. This video game controller is also connected to an Internet interface (905). A typical example of an Internet interface is a computer equipped with modem. This Internet interface also can be placed inside of the video game control box. Both the Internet interface (905) and the data decoder (903) are connected to a storage unit (907) and a video game control unit (909). The storage unit (907) is a memory device used to store data. Typical examples of the storage unit are hard disk or tape. The video game controller (909) is the same as current art video game controllers except that it has programmable firmware to allow re-configuration for different games. Video game players can play different games by programming the controller firmware.

For a system which does not have TV interface (901), a player need to scan the web side of a video game provider, then load the whole set of a video game program into the game controller (909) in order to play a new game. If there are 1 million players wanting the same game, the same procedures will be repeated one million times. Most likely the web site will be jammed by requests for popular games. Even if the web side has enough bandwidth to handle the request, it is still a tremendous waste in resource.

When the system is equipped with TV interface (901), the procedures to obtain a new game will be extremely efficient. The video game player uses the Internet interface (905) to select a new game. The game provider sends a “decoder key” to the player. This “decoder key” tells the data decoder (903) when and how to down load data from the TV interface (901). High volume data such as the video images of web pages and the game programs are transferred through the TV interface using data transfer methods of the present invention. The Internet interface (905) only handles slow activities such as selection of game or transfer of the decoder key. The same decoder key can be given to multiple users, so that when many users are requesting for the same data simultaneously, the provider only need to send one copy through the TV interface. A data transfer that is initiated immediately after a request from the user is called a real time (RT) data transfer. One problem for RT data transfer is that players usually send out their requests at different time. If the provider always sends out the data from the very beginning whenever a request is received, the same data will need to be sent many times. One way to solve the problem is to delay the data transfer, accumulate many requests, then send one copy out to satisfy all the requests. This method is called delayed data transfer. The other way to solve the problem is to break a large file into small packages. The game players do not need to receive a large data file from the beginning. Small packages can be received out of sequence. The final data file is established after all packages are received. This method is called package data transfer. Using package data transfer, the game provider simply keep on sending out packages of requested games as soon as there are requests for that game. All the players requesting the same game are given the same key. Whenever a player has collected all the necessary packages, a signal is sent back to the provider to notify end of request. The game providers stop the procedure when all the requests are satisfied. Another method to solve the problem is to schedule the TV data transfer ahead of time. This method is especially useful for introduction of a brand new game. All the players wanted the new game are given a key to access the data. Data for the new game is sent out at a pre-defined time to all players. In this way, the provider only needs to send one copy once. Another method is for the provider to send data to players who are likely to want the data before the player actually request for the game. These pre-sent data are stored in the data storage unit (907). When the player actually sends out a request, game control software will first look into the storage unit (907). If the game already pre-sent into the storage unit, the provider only needs to give the player a key to activate the game; there is no more need for data transfer. Only when the requested game is not found in the storage unit (607) does the provider need to send new data to the player. FIG. 9(b) shows a float chart for the above communication procedures. The data transfer methods of the present invention are so efficient that they can support thousands of people playing the same game simultaneously. To support such a large scale game, each video game system should store the game map. Players send commands through conventional Internet connections, while a central system update the results through TV data transfer methods of the present invention. The TV signal updates all the game maps in all the involved individual systems with a single broadcast. In this way, thousands of people can play the same game without jamming the system.

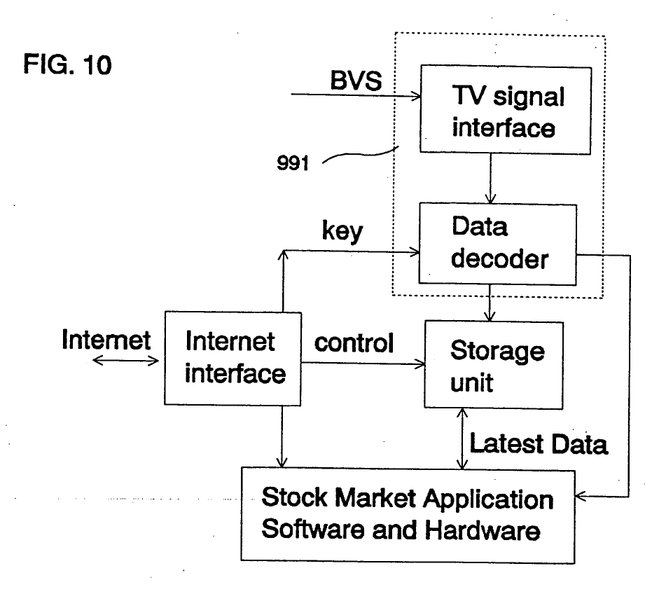

Another practical application of the present invention is a real-time stock market data update system. FIG. 10 shows an example of stock market data update system of the present invention. This system is identical to current art stock market data update system except for a TV signal interface (991) that can obtain data from TV signals. The system is still connected to internet. Users still send their requests through Internet. The software programs used to display stock market information are the same as current art software programs. The only difference is that there is a parallel data path from the stock information provider to all users through TV data transfer methods of the present invention. In a prior art system, the most updated stock prices are sent to millions of users through Internet. That means millions of duplicated copies are sent to individual users. Using the TV data transfer methods of the present invention, the stock information providers only need to send out one copy of the latest stock data. Updating latest stock price only requires a few thousand bits per second. Any one data transfer method of the present invention will easily handle the bandwidth requirement, while all the users can obtain real-time stock prices simultaneously with minimum delay. Note that the system does not have to use a computer. A video game controller described in FIG. 9(a) can be programmed to have stock update capability.

While specific embodiments of the invention have been illustrated and described herein, it is realized that other modifications and changes will occur to those skilled in the art. It should be understood that the above particular examples are for demonstration only and are not intended as limitation on the present invention.

Data transfer system of the present invention uses existing TV broadcast systems to send data. It will satisfy the bandwidth requirement for many applications without any changes to existing system. The system requires little resource to implement. It is the most cost efficient method to solve the bandwidth problem, and the system can be established in a short time.

The most important limitation for these data transfer system is that they are one-way broadcast system. The transmission path tends to be noisy. It is therefore necessary to implement data quality control methods such as parity check, check sum, error correction code, Hemming code, . . . etc. Those methods to assure data quality for a noisy media are well-known to the art. There is no need to describe them in details. Another important issue is security. Security measured to protect broadcast data should be implemented for data with security concerns.

Besides TV, the present invention is also applicable to other types of communication systems. One practical example is radio. Radio signals comprise frequency modulated (FM) or amplitude modulated (AM) signals carried by a predefined channel frequency. We can transfer data through existing radio networks without disturbing normal voice signals using methods in the following examples.

Below Haring Range Radio (BHRR) Data Transfer

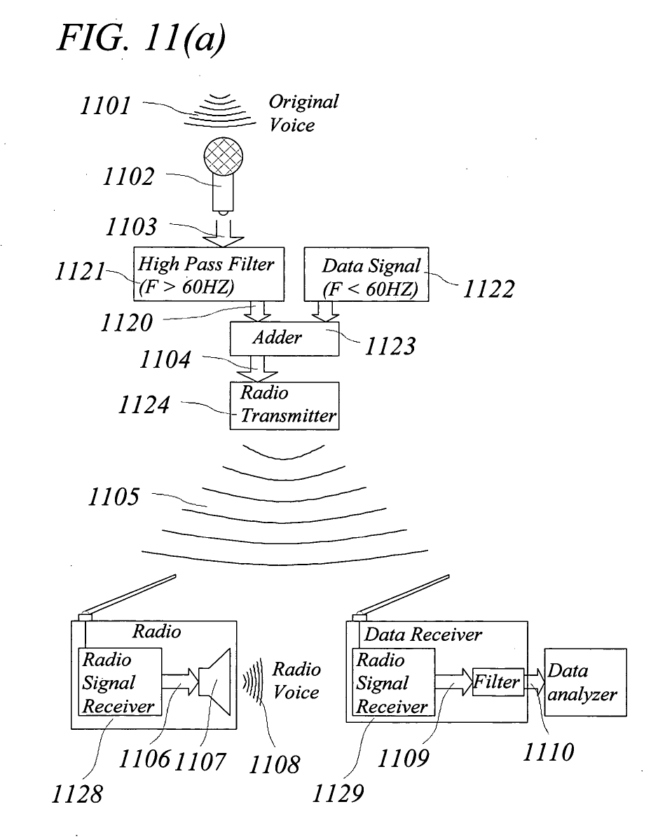

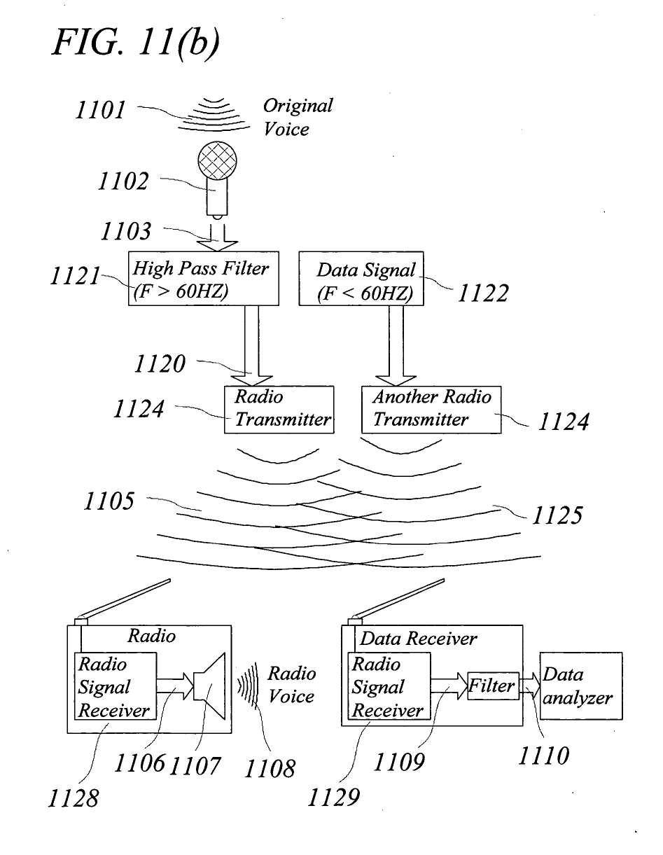

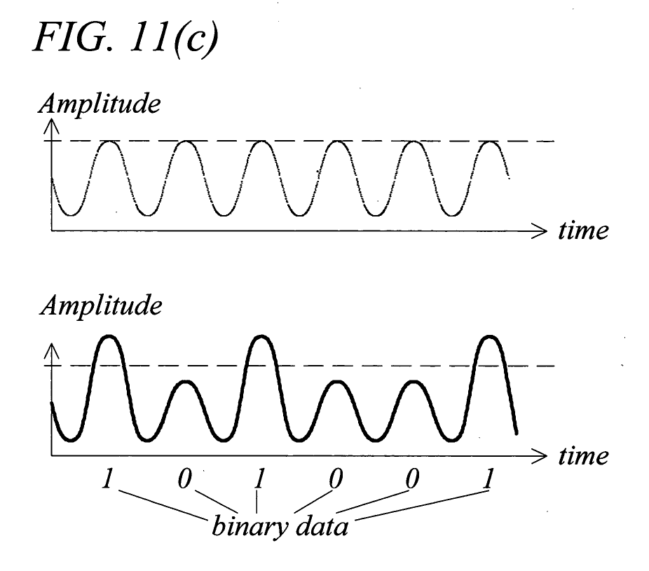

Human ears are not sensitive to sound at frequency lower than 60 HZ. We can modify low frequency components of sound waves without disturbing the sound detected by human ears. FIG. 11(a) is the simplified block diagram for an example of BHRR data transfer system. The original voice (1101) is translated into electrical signals (1103) by a microphone (1102). Low frequency component (lower than 60 HZ) of the microphone output signal is removed by a high pass filter (1121). This output (1120) of the filter is combined with low frequency (1122) data signal by a signal adder (1123). This combined signal (1104) comprises two components: (a)filtered voice signals (1120) at frequency higher than 60 HZ and (b)data signals at frequency lower than 60 HZ. The combined electrical signal (1104) is converted into FM or AM radio signal (1105) by a radio transmitter (1124), and broadcasted through existing radio network. When this broadcasted signal (1105) is received by a prior art radio (1128), the radio signal receiver inside the radio demodulates the broadcasted signal (1105), and send the demodulated signal (1106) to a speaker (1107). Besides noise and distortion, this demodulated signal (1106) is the same as the adder output signal (1104). Therefore, the voice (1108) output by the radio is the same as the original voice (1101) except its low frequency (lower than 60 HZ) components. Since human ears are not sensitive to the low frequency components, the radio output sounds the same as original voice. In the mean time, the same broadcasted signal (1105) reaches a radio data receiver (1129) of the present invention. This data receiver also has a radio signal receiver that can be the same as the one used by prior art radio. The demodulated signal (1109) extracted by the data receiver can be identical to the demodulated signal (1106) of the prior art radio (1128). This demodulated signal (1109) is sent through a low pass filter to extracts low frequency data signal (1110) that is identical to the original data signal. The resulting data signal (1110) is sent to data analyzer for further processing. In this way, we can transfer data using existing radio networks without interfering normal radio operations. All the technologies described here are well known to those familiar with prior art radio networks. Such BHRR data transfer system is relatively simple comparing to TV signal processing systems. A radio data receiver of the present invention can be as simple as adding one low pass filter to a prior art radio. The cost and initial barriers for BHRR applications are therefore very small. The major disadvantage for BHRR is its small bandwidth caused by limitation in low data frequency.

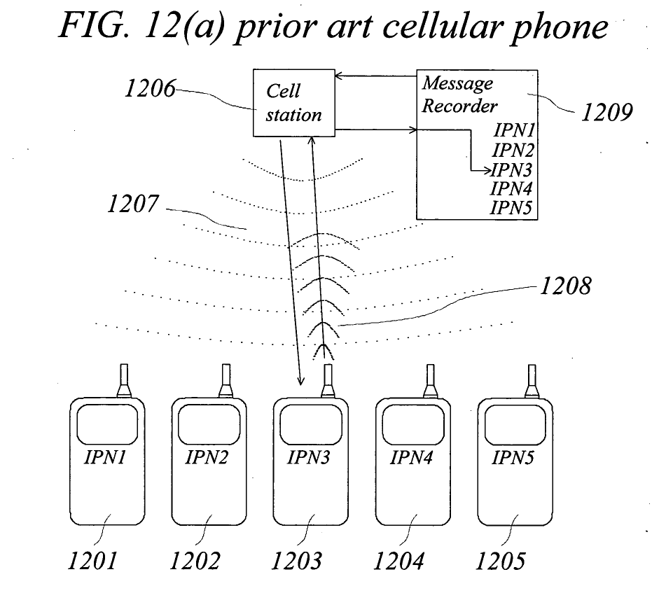

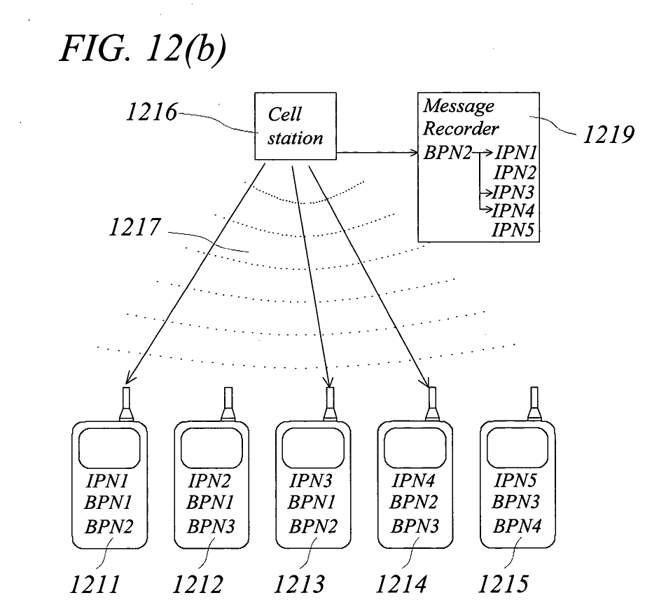

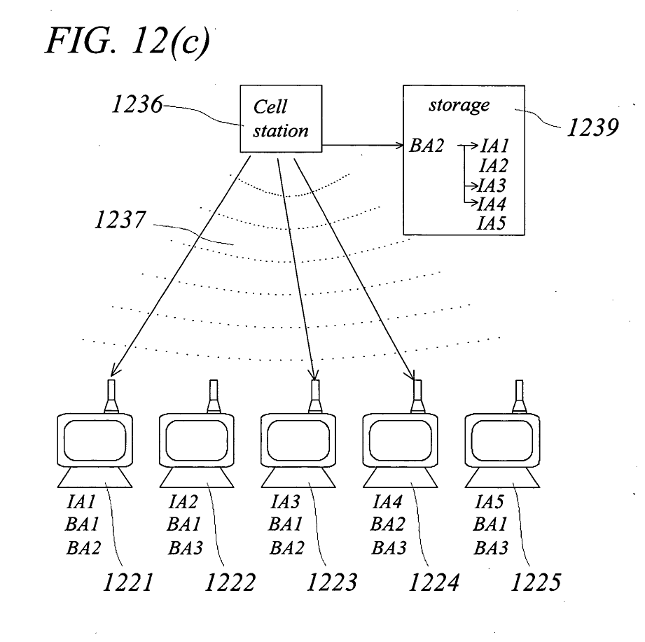

For BHRR, we do not need to merge the data signal with the voice signal at the same radio transmitter. FIG. 11(b) shows the situation when the low frequency data signal (1122) is transmitted using another radio transmitter (1124) through separated broadcast radio signal (1125). The overall results of the system in FIG. 12(b) will be the same as the results in FIG. 12(a). A prior art radio (1128) will output demodulated voice signal (1105) and data signal (1125) simultaneously, but that has no effect to radio listeners because the demodulated data signal is out of hearing range. A data receiver (1129) will filter out the high frequency voice while using remaining low frequency data signals. The capability of using different broadcast transmitter allows additional flexibility for many applications.

Pre-Defined Voice Radio Data Transfer (PDVR)

A pre-defined voice is a voice signals that is known to both the data sender and the data receiver. For examples, the “Doo Doo Dooo” (DDD) tune sounded before an announcement such as “it is 5 minutes after 10 pm”, the music broadcasted before a particular program, or a particular part of a commercial. Small modification of pre-defined voice signal has no effect to radio listeners, while a data receiver can compare known signal pattern with broadcasted signal pattern to extract transferred data. FIG. 11(c) shows a simplified example when the DDD tune is used for data transfer. For simplicity, we assume the signal for the DDD tune is simple monochromic waveform as shown by the dotted line in FIG. 11(c). To transfer data, the DDD tune amplitude is modulated as shown by the solid line in FIG.11(c). Binary data ‘1’ is represented by larger amplitude while binary data ‘0’ is represented by smaller amplitude. Since the DDD tune is only used as a symbol to draw listeners' attention, radio listeners won't care if it sounds slightly different. The effect on radio listener is therefore negligible while a data receiver can extract data from the modulated DDD sound. The example in FIG. 11(c) is simplified for easy understanding, while actual data transfer is more sophisticated. The original waveform does not need to be monochromic; any waveform known to the receiver can serve the purpose. The data can be transferred in wide varieties of formats including AM, FM, or combination of AM/FM formats. PVDR provides higher data rate than BHRR because of higher signal frequency.

While specific embodiments of the invention have been illustrated and described herein, it is realized that other modifications and changes will occur to those skilled in the art. It should be understood that the above particular examples are for demonstration only and are not intended as limitation on the present invention. The above PDVR data transfer method is based on similar principle as TV PODT method of the present invention. Other methods used for TV data transfer also can be applied for radio data transfer. For example, similar to TV DODT method, we certainly can use dedicated time for radio data transfer.

In the past few years wireless communication systems, such as cellular phone systems or wireless internet systems, have grown into major communication networks. Modern wireless communication systems use “band width reuse” methods to increase overall communication bandwidth. A wide area communication network is divided into a large number of smaller areas called “cells”. The same frequency channel can be reused within each individual cell to achieve larger overall bandwidth. Such cellular communication networks are different from TV or radio broadcast systems in the fact that it is actually not used as a broadcast system over the whole network. Most of existing applications focused on one-to-one communications such as cellular phone or internet services. In the mean time, existing wireless networks can be treated as a combination of large number of small broadcast systems. We can broadcast a message in selective subset of cells in the overall cellular system. Using the present invention, the potential and the flexibility to broadcast large quality of data through those existing wireless networks are higher than TV and radio combined.

FIG. 12(a) is a simplified block diagram illustrating operations of a prior art cellular phone system. In each communication cell, a cell station (1206) controls communication activities within the cell. This cell station is linked to other cell stations to form a complete network. Within a given cell, there can be many cellular phones (1201-1205). Each cellular phone is identified by an individual phone number (IPN1-IPN5). The individual phone number for each phone is different from that of any other phones. When there is an incoming phone call for phone number IPN3, the cell station (1206) sends out signals (1207) to “ring” the number IPN3. All the phones (1201-1205) in the cell receive the ringing signal, while only the one (1203) identified with the right number (IPN3) can response to the ring with its own signal (1208). The cell station assigns a channel to that phone, and establishes a two-way one-to-one communication between the selected phone (1203) through the cell station into the network with the caller. Each phone occupies one frequency channel at a time. Other phones in the same cell (1201, 1202, 1204,1205) also can connect to the communication network, but they need to use different channels. Sometimes, the selected user may not be able to response (busy or off), a message recorder (1209) may take over to record the message so that the user can retreat recorded message later.

The above example provides a simplified description for a highly sophisticated system. The cellular system can handle the situation when a phone is moving from one cell to the other cell, and there are many sophisticated protocols to handle different situations. The signal transferred in current art cellular system is no longer limited to voice. Video images and internet connections are becoming more and more common. With data compaction methods, the efficiency of wireless data transfer methods is improving in dramatic rates. However, these highly sophisticated communication systems still have wasted bandwidth available. The most significant wastes are the idle channels in each cell. The number of phone calls each cell station need to service at the same time is an unpredictable number so that most of cell stations have more channels than necessary. That means most of time we have available idle channels in each cell station for data transfer of the present invention. Another waste is in the one-to-one nature of prior art system; a message suitable for broadcasting is currently executed by large number of one-to-one operations. The present invention provides efficient methods to utilize these wasted resources with minimum modifications in existing communication systems.

FIG. 12(b) illustrates one example of data transfer methods of the present invention using an existing cellular phone system. We use the same communication cell and the same cell station (1216) in prior art systems. The cellular phones (1211-1215) of the present invention can be almost identical to prior art cellular phones (1201, 1205) except that each phone can have more than one identification phone numbers. Each cellular phone still can be identified by an individual phone number (IPN1-IPN5) that is different from that of any other phones so that we still can have all the prior art services. The difference is that these phones (1211-1215) also can response to additional broadcast phone numbers (BPN). Broadcast phone numbers (BPN) are different from prior art individual phone numbers (IPN) by the function that more than one phone can response to the same BPN. For the example in FIG. 12(b), three phones (1211, 1212, 1213) response to BPN1, three phones (1211, 1213, 1214) response to BPN2, three phones (1212, 1214, 1215) response to BPN3, and one phone (1215) response to BPN4. When there is a broadcast message for BPN2, the cell station (1216) sends out signals (1217) to “ring” the number BPN2. All the phones (1211-1215) in the cell receive the ringing signal, while those phones (1211,1213,1214) programmed with BPN2 all response to the ring. There are many ways to handle this broadcasted data transfer. The simplest way is a one-to-many data transfer while all the ringed phones record the data for further processing; there is no feedback from the phones (1211-1215) to the station (1216). A more complex broadcast method may require feedback from phones. Sometimes, the ringed user may not be able to response (busy or off), a message recorder (1219) may take over to record messages. This message recorder (1219) is similar to prior art message recorder (1209) except that it needs to be able to store the same message for multiple users (IPN1, IPN3, IPN4) according to a pre-defined lookup table. For applications that do not require users to response, there is actually no need to ring individual phones (1211-1215). We can directly send the broadcast message to the message recorder (1219) so that individuals can take their time to lookup the broadcasted messages. Since broadcasted messages often do not require immediate response, we can wait for available idle channels to send the message. This method also allows us to send a message to multiple users using only one channel.

Similar principles are applicable to wireless internet systems as illustrated by the simplified block diagram in FIG. 12(c). In each prior art wireless internet cell, a cell station (1226) controls internet activities within the cell. This cell station is linked to other cell stations or directly linked to high speed internet connections to form a complete network. Within a given cell, there can be many internet clients (1221-1225). Each internet client is identified by an individual internet address (IA1-IA5) such as shau@yahoo.com. The internet address (IA) for each client is different from the IA's of other clients. When a client (1223) want to “log on”, the cell station assigns a channel to that client, and direct all incoming messages addressed to IA3 to that client (1223). Each client occupies one frequency channel at a time. Other clients in the same cell (1221,1222,1224, 1225) also can log on, but they need to use different channels. Sometimes, the selected user may not be able to response (busy or off) to an incoming message, a storage device (1229) may take over to record the message so that the user can retreat recorded message later.

Such one-channel-per-client wireless internet system has the same wasted resources as prior art cellular phone system. There are idle channels in each cell, and a message suitable for broadcasting is sent by large number of one-to-one operations. We can apply similar methods to harvest those wasted resources. Besides individual internet addresses (IA1-IA5), each client also can response to broadcast addresses (BA). Broadcast address (BA) is different from individual internet address (IA) by the function that more than one client can response to the same BA. For the example in FIG. 12(c), four clients (1221, 1222,1223, 1225) response to BA1, three clients (1221, 1223, 1224) response to BA2, and three clients (1222, 1224, 1225) response to BA3. When there is a broadcast message for BA2, the messages (1227) sent by cell station (1226) are received by all those clients (1221, 1223, 1224) programmed with BA2. There are many ways to handle this broadcasted data transfer. The simplest way is a one-to-many data transfer. A more complex broadcast method may require feedback from clients. A single client also can be allowed to logon with more than one address simultaneously through multiple channels. Sometimes, the targeted clients may not be able to response (busy or off), a storage device (1229) may take over to record message. This storage device (1229) is similar to prior art storage device except that it needs to be able to store the same message for multiple clients (IA1, IA3, IA4) according to a pre-defined lookup table. For applications that do not require users to response, there is actually no need to connect individual clients (1221-1225). We can directly send the broadcast message to the storage device (1229) so that individuals can take their time to lookup the broadcasted messages. Since broadcasted messages often do not require immediate response, we can wait for available idle channels to send the message. This method also allows us to send a message to multiple users using only one channel.

While specific embodiments of the invention have been illustrated and described herein, it is realized that other modifications and changes will occur to those skilled in the art. It should be understood that the above particular examples are for demonstration only and are not intended as limitation on the present invention. Principles of the present invention have been demonstrated by specific. examples in TV, radio, cellular phone, and wireless internet systems. For those familiar with prior art broadcast or communication systems, wide varieties of applications will be obvious upon disclosure of the present invention.

Communication activities usual appear in random rates; there are communication peaks requiring extremely high bandwidth, and there are slow times with low activities. Existing communication systems are designed to support the highest communication peaks so that there are wasted bandwidth available for data transfer of the present invention. A TV channel has enough bandwidth to transfer the most complex motion pictures so that wasted bandwidth is available for data transfer of the present invention because most pictures are less complex. A radio channel has enough bandwidth to transfer the most complex sound so that wasted bandwidth is available for data transfer of the present invention because human can not distinguish every detailed voice. A cellular phone station is designed to support maximum phone calls so that idle channels are usually available for data transfer of the present invention. Data transfer methods of the present invention explore available bandwidth in existing communication systems following the following steps: (1) identify the wasted resources in an existing communication system, (2) find methods to insert data signals into existing communication signals with tolerable disturbance to prior art receivers, (3) send both data and prior signals through existing communication systems, and (4) allow prior art receivers to use prior art communication with tolerable disturbance while data receivers of the present invention can receive data using the same communication system.

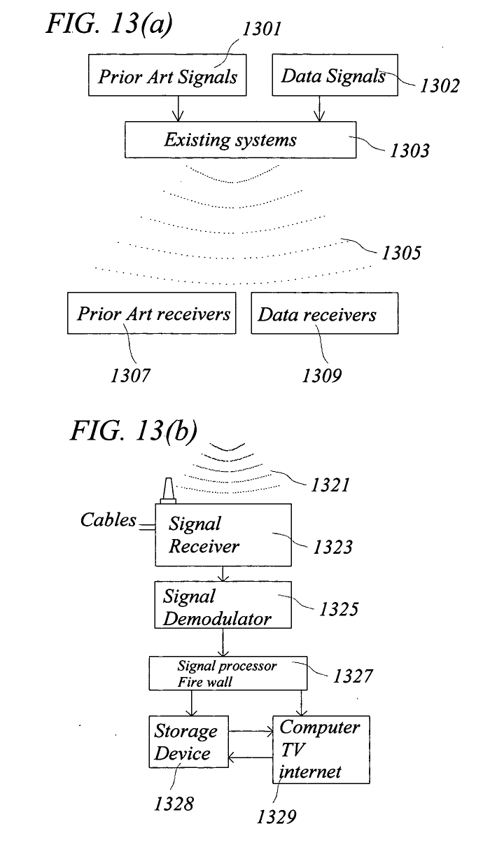

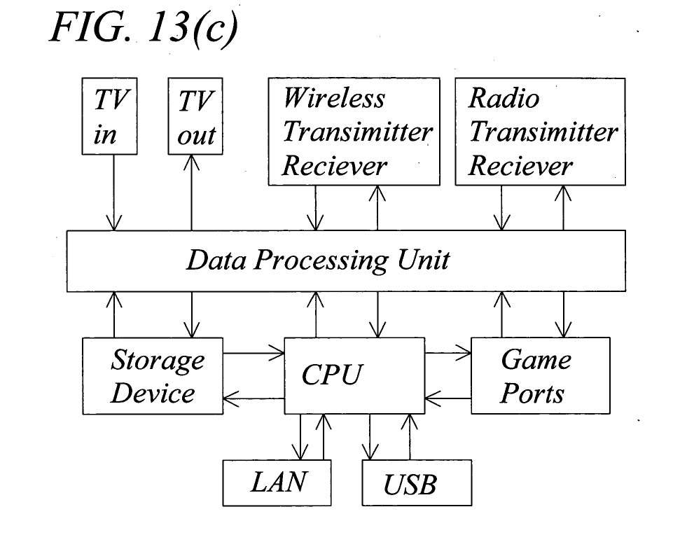

FIG. 13(a) is a top level block diagram for data transfer systems of the present invention. Prior art signals (1301) are merged with data signals (1302) and broadcasted through existing systems (1303). The data signal of the present invention is therefore embedded in prior art signals (1305) broadcasted through existing systems. The combined broadcast signals (1305) are received by both prior art receivers (1307) and data receivers (1309) of the present invention. A data transfer method of the present invention does not disturb prior art receivers (1307) while data receivers (1309) of the present invention can obtain the data through existing communication systems. FIG. 13(b) shows a typical block diagram for a data receiver of the present invention. Broadcasted signals, such as TV, radio, wireless internet, or cellular phone signals, are usually transmitted by electrical magnetic waves (1321). Sometimes the broadcasted signals also can be transmitted through wired media such as cables, phone lines, or optical fibers. We need to have a signal receiver (1323) that can capture those broadcasted signals. A typical example for the signal receiver (1323) is an antenna or a cable associated with filters and amplifiers. The electrical output of the signal receiver is sent to a demodulator (1325) that extracts transmitted signals out of carrier signals. Typical demodulators comprise filters, equalizers, and phase locked loops. The output of the demodulator (1325) is sent to signal processors and associated software and/or hardware (1327) to extract useful information out of electrical signal. Digital signal processing is the most popular current art signal processing method. The software often involves fire wall mechanisms to prevent unwanted data from coming into our system. The resulting data are usually stored into storage devices (1328) such as computer hard disks, tapes, or compact disks. The data are later sent to interface devices (1329) such as TV, computer, or internet. Sometimes we may send data directly to those interface devices (1329) without going through storage devices (1328). The present invention uses existing communication systems for data transfer. The equipments and technologies used by the present invention all can be implemented by components well-known to those familiar with prior arts. The costs and technology barriers are therefore very low.

Upon disclosure of the present invention, applications require transferring large amount of data to millions of people will become practical. A data receiver can obtain data from TV, radio, or wireless communication networks using multiple data transfer methods of the present invention as shown in FIG. 13(c). The total available bandwidth can easily exceed gigabits per second. Applications requiring large amount of data such as movies, software, books, video games, . . . etc can be transferred to millions of people at very low cost. The data receiver can be connected to storage devices such hard disks, compact disks, tapes, . . . etc. The system can be controlled by central processing units (CPU) in the same ways as prior art computers. We certainly can link this system to other systems through universal series bus (USB), local area networks (LAN), the internet, cellular phone, and other devices such as game controllers. All the technologies needed for those applications are available right away because we are using existing communication systems.

Mapping Applications

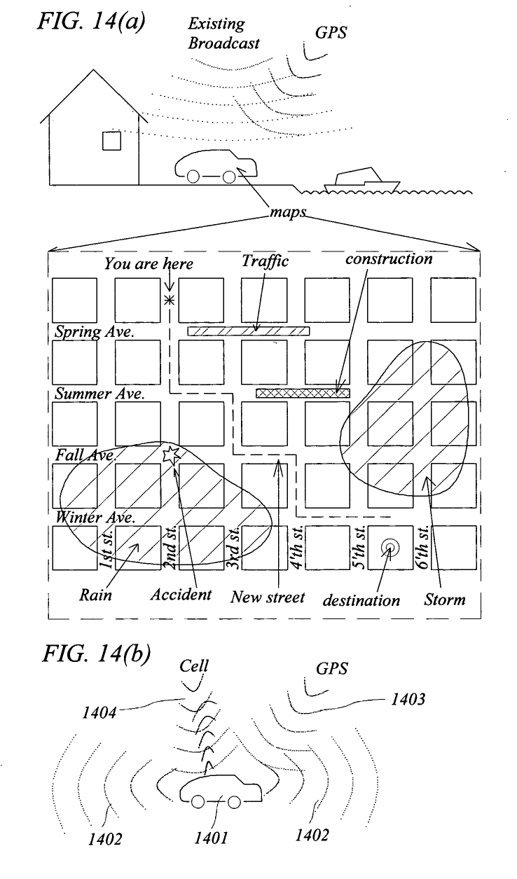

One interesting application is to integrate data transfer methods of the present invention with global positioning system (GPS) as shown in FIG. 14(a). Vehicle GPS mapping device is already a popular feature. Prior art vehicle GPS mapping devices use GPS to determine the location of a vehicle, and use mapping database/software to provide directions. However, such prior art mapping system is not able to adapt for real time changes in driving conditions. Using data transfer methods of the present invention, we can provide the most updated information to GPS mapping devices on vehicles for optimum driving directions. FIG. 14(a) shows examples of possible situations. If a care is equipped with GPS and data receiver of the present invention, it can receive the most updated information. This data receiver can us TV, radio, or wireless communication signals to receive those data. For example, we can update the latest maps including construction sites and new roads. We can provide the latest traffic conditions as well as weather conditions, and direct the vehicles to avoid traffic jams and weather hazards. We also can report latest accidents and direct passenger vehicles to avoid the accident site while directing ambulances to the accident site.

To support the above application, we need to provide an efficient system to report real time events. One method is to establish a central station collecting and broadcasting the most updated traffic, weather, and accidents. The function of such central station is similar to the function of current art news stations. The major problem for this approach is the delay caused by manual reporting may be too long for critical events such as accidents or hazards. A more efficient method is to use a large number of report stations. Most of prior art service vehicles such as police cars, ambulances, or fire engines already equipped with wireless communication devices. With simple modifications, their existing prior art wireless equipments will be able to transmit signals of the present invention. The easiest method for this application is probably the BHRR method described in FIG. 11(b). For example, the first service vehicle arrives an accident site should turn on it transmitter of the present invention. The signals transmitted from the vehicle can tell passenger vehicles equipped with data receivers of the present invention to avoid the accident site. It also can make it much easier for other service vehicles to reach the accident site. It is even better if the report station (1401) also has GPS (1403) mapping capabilities as shown in FIG. 14(b). In this way, the location of the accident site also can be broadcasted through signals (1402) of the present invention. Another method to obtain location of the accident side is to use cellular communication system. The report station (1401) can send cellular phone signals (1404) to the nearest cell station. Since we know which cell station receives the signal, we know the accident site is within that particular cell. Using cell station to determine location is not as accurate as GPS, but it is enough for many applications such as weather reports. The transmitter needed for this method can be manufactured using existing radio or cellular phone components. There is no need to discuss its detailed structures. A report station does not have to be a mobile station. For example, we can use a fixed station equipped with weather sensor and transmitters of the present invention to report weather conditions. The signals transmitted by those small transmitters in report stations usually can not reach long distance, but that is actually an advantage because accidents or weather conditions are only useful for local areas.

Emergency Response System

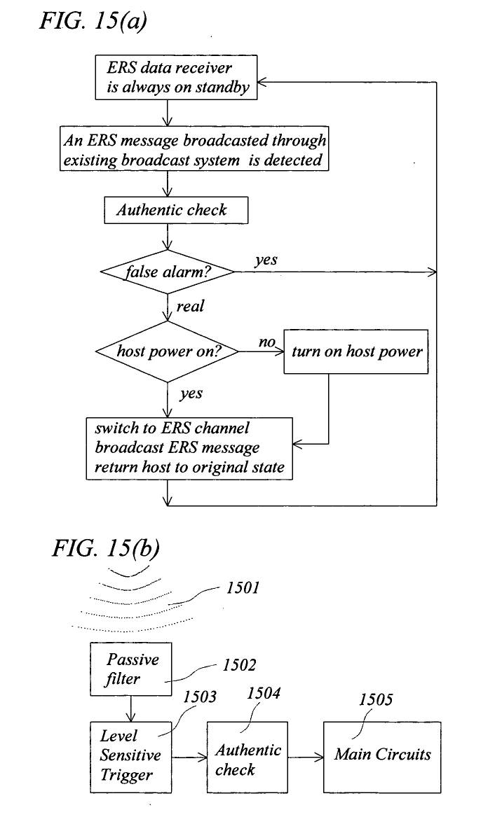

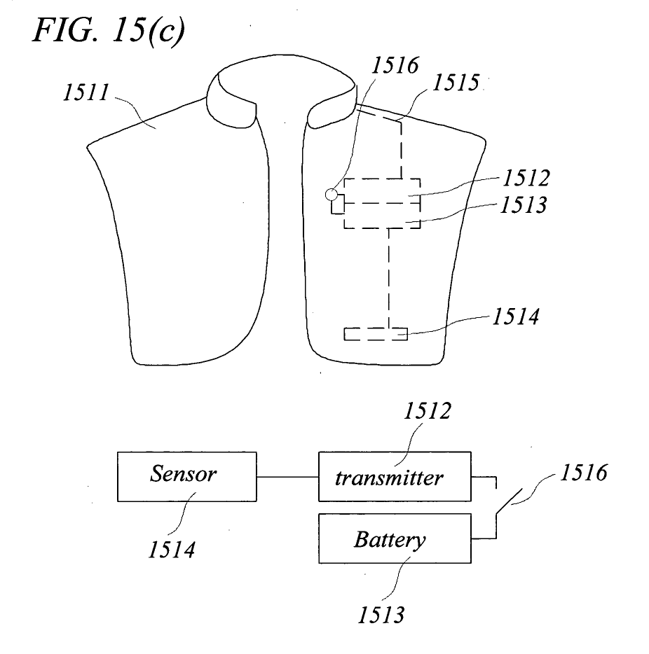

Normally, the present invention avoids disturbing prior art users for cost consideration. When the present invention is used to support an Emergency Response System (ERS), the priority is different. It is essential to make sure everyone in danger receive ERS messages while disturbance of other activities are not important. Current art ERS takes over active programs to broadcast emergency messages. However, people still need to turn on their TV or radio and tune in the right stations to receive the ERS messages. It is therefore desirable to have a more reliable ERS. FIG. 15(a) shows the float charge for an ERS of the present invention. An ERS receiver of the present invention remains at standby state even when its host device (TV, radio, or cellular phone) is turned off by user. The ERS messages can be transferred through TV, radio, or wireless systems using any one of the data transfer methods of the present invention. It is worthwhile to reserve a channel dedicated for ERS purpose in those broadcast systems. An ERS message should include a series of identification code. Authentic check is essential because a false ERS message can be very dangerous. When an ERS data receiver receives verified ERS messages, it is allowed to control the power of the host device, and overwrite existing activities to send out ERS messages. Once the procedure is done, the host device is returned to its original state.

For example, a TV can have an embedded ERS data receiver of the present invention. This data receiver is always on, even when the TV is turned off, and it is detecting and waiting for a specific data sequence indicating ERS message. The ERS message can reach the data receiver in any one of the data transfer methods of the present invention. For example, it can use PODT method of the present invention carried by channel 2 TV signal. This ERS signal does not need to be TV signal. For example, we can install a data receiver that response to BHRR radio signal. When an ERS message is detected and it passed authentic checks, the TV is turned on even when it was originally off, and its channel is switched to broadcast ERS message. After ERS broadcast procedures are completed, the host TV is returned to original state. Similarly, an ERS of the present invention can be embedded in radios, especially vehicle radios. All it takes is to add a low pass filter for one of the radio channel. This embedded ERS data receiver is always on standby even when the radio is not turned on. A radio ERS message can use any data transfer method of the present invention, it also can use a pre-defined channel dedicated for ERS messages. When the embedded ERS data receiver detects an ERS message that passed authentic checks, the radio is forced to broadcast ERS message. Similarly, a hiker can carry a cellular phone equipped with an ERS data receiver of the present invention. This ERS data receiver is always on standby even when the cellular phone is not turned on. A cellular ERS message can use a pre-defined channel dedicated for ERS messages, or it can use a special broadcast phone number as identification. Dedicating a cellular channel is not as expensive as dedicating a TV or radio channel. When the ERS data receiver detects an ERS message that passed authentic checks, the cellular phone is forced to ring and the hiker will always receive hazard information. Power saving is very important for such ERS data receiver embedded in cellular phone. If the power consumption of this always-on receiver is too high, it will drain the battery of the cellular phone so that the cellular phone will not be able to response to the ERS message. FIG. 15(b) shows a low power design for cellular phone embedded ERS data receiver. The input signal (1501) is detected by antenna and sent to a passive filter (1502) that does not consume any power from the host. This passive filter only allows signals at ERS carry frequency to reach a level sensitive trigger (1503). This level sensitive trigger consumes very low power until the amplitude of the input signal reaches a pre-defined value for a pre-defined period of time. When the trigger condition is met, that means a valid ERS message maybe coming in, the trigger circuit (1503) turns on an authentic check (1504) mechanism. This authentic check (1504) mechanism is normally turned off to consume no power. When it is turned on by the trigger circuit (1503), it executes authentic checks to make sure incoming signals are real ERS signals. Once the input signal (1501) passed authentic checks, the main circuits (1505) are turned on to execute ERS broadcasting procedures. In this way, most of the circuits are at low power state until they need to be used. At standby condition, only the passive filter is reacting to input signals so that almost no power is wasted.

The above examples show methods for broadcast systems to notify individuals about hazard conditions. FIG. 15(c) shows a device for an individual to report personal danger using existing communication systems. A life vest (1511) is equipped with a battery (1513) powered transmitter (1512) hidden in its chest pocket. The power of this transmitter is controlled by a power switch (1516) as well as a sensor (1514). In this example, the sensor turns on when it is soaked with water. This water sensor can be as simple as a circuit measuring the resistance of a piece of sponge. This sensor (1514) is hidden inside of the life vest so that normally it won't get wet even when it is raining. When the person wearing this life vest (1511) is dropped into water, the corner of the life vest containing the sensor is designed to soak enough water to turn on the sensor. This sensor triggers the transmitter to send out ERS signals. These ERS signals can have many kinds of format. The simplest example would be signals that are the same as prior art cellular phone dialing a special ERS number. Anyone familiar with prior art can make such transmitter using well-known cellular phone components at very low cost. The cellular phone system will be able to detect and locate the location of the person based on which cell station received the ERS signals. In this way, a small child who is not able to call for help would be able to send out ERS requests.

The present invention provides methods to send data through existing communication systems without disturbing existing users and reliable methods to send ERS information using existing communication systems. While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

I claim:

1. A data transfer method comprising steps of
(a) examining an existing communication system for finding a time slot with unused bandwidth;
(b) generating a data-carrying signal by inserting into said communication system a hidden-from-existing-user data signal in said time slot; and
(c) transmitting said data-carrying signal to existing users and data receivers through said existing communication system.

2. The existing communication system in claim 1 is a television broadcast system.

3. The existing communication system in claim 1 is a radio broadcast system.

4. The data transfer method of claim 3 wherein:
said step (b) of generating a data-carrying signal by inserting data signal at frequencies below human hearing ranges into said radio signal.

5. The data transfer method of claim 3 wherein:
said step (b) of generating a data-carrying signal by inserting data signal into a pre-defined voice that is know for both data transmitters and data receivers.

6. The existing communication system in claim 1 is a cellular phone communication system.

7. A plurality of receivers used in said communication system in claim 6 can be activated by the same broadcast phone number using the same channel in the same cell simultaneously.

8. A message storage device used in said communication system in claim 6 can store the same message to a plurality of users having the same broadcast phone number.

9. The existing communication system in claim 1 is a wireless internet communication system.

10. A plurality of users in said wireless internet communication system in claim 9 can be activated by the same broadcast internet address using the same channel in the same cell simultaneously.

11. A message storage device used in said communication system in claim 9 can store the same message to a plurality of users having the same broadcast internet address.

12. An application of the data transfer method in claim 1 is integrated with global positioning system (GPS) for reporting position dependent information.

13. An application of the data transfer method in claim 1 is integrated with cellular communication system to determine the area location by the location of the cell station which received messages.

13. A device for receiving messages from an emergency response system (ERS) comprising:
(a) a signal receiver for receiving ERS signals transmitted from an existing communication system,
(b) means to turn on the power of a human interface device, and
(c) means to switch the active channel of a human interface device for delivering ERS messages.

14. The human interface device in claim 13 is a television.

15. The human interface device in claim 13 is a radio.

16. The human interface device in claim 13 is a cellular phone.

17. The human interface device in claim 13 is a computer.

18. The signal receiver in claim 13 receives television signals.

19. The signal receiver in claim 13 receives radio signals.

20. The signal receiver in claim 13 receives cellular phone signals.

21. The signal receiver in claim 20 comprises a passive filter for screening incoming ERS messages before activating power consuming devices.
